(19) United States
(12) Patent Application Publication
(10) Pub. No.: US 2007/0115904 A1
(43) Pub. Date: May 24, 2007

(54) Method and device for integrating a cellular network and a ubiquitous network

(76) Inventors: Lan Chen, Beijing (CN); Hidetoshi Kayam, Beijing (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/516,916

(22) Filed: Sep. 6, 2006

(30) Foreign Application Priority Data
Sep. 6, 2005 (CN) 200510098416.2

(51) Int. Cl. H04Q 7/24

(52) U.S. Cl. 370/338

(57) ABSTRACT

Embodiments of the present invention relate to a method for integrating a ubiquitous network and a cellular network. The cellular network may adopt time division or frequency division duplex communication and the communication mode may be time division multiplexing, frequency division multiplexing or packet division multiplexing. One embodiment of the method comprises the following steps: the mobile terminal determining whether there are packets to be transmitted to the base station; if there are packets to be transmitted to the base station, the mobile terminal transmitting the reservation request signal to the base station, after receiving the reservation requests from all the mobile terminals, the base station generating uplink slot resource allocation information for the mobile terminal and the ubiquitous terminal and transmitting the information to the mobile terminals, and after receiving the information, the mobile terminals which have packets to be transmitted transmitting the uplink packets.

### PRIORITY

The present application claims priority to and incorporates by reference the entire contents of Chinese patent application No. 200510098416.2, filed in China on Sep. 6, 2005.

### FIELD OF THE INVENTION

The present invention relates to a method and device for network convergence, and more particularly to a method and device for integrating a cellular network and a ubiquitous network.

### BACKGROUND OF THE INVENTION

Currently, the communication terminals with low transmitting power, such as the terminals in the wireless LAN and PAN (Personal Area Network), are being used more and more applications, thereby forming a network everywhere, i.e. a ubiquitous network. Since the ubiquitous network has obtained more and more applications, it is important to integrate the ubiquitous network and the cellular network together so that the mobile users may conveniently access the large amount of resources in the ubiquitous network.

The traditional methods for integrating a ubiquitous network and a cellular network include the dual-mode terminal method, which uses the dual-mode terminal to relay the information in the ubiquitous network. However, this method requires the terminal to turn on the dual-mode transmitters and receivers. Although this method can greatly reduce the interference between the two modes, it lacks compatibility in different systems and this kind of terminal costs too much in terms of power.

The traditional integration methods also include the multi-hop method. In the TDD based multi-hop communication, especially when the home antenna is used, a large interference in the slot of the reverse communication will be created. In the multi-hop communication based on FDD, since independent channel resources have to be provided for the relay link (home antenna)s, the resource usage ratio will decrease. In addition, in this method, the mobile terminal relays the packets from the ubiquitous terminal to the base station and both the uplink and the downlink have to be guaranteed before the communication establishes. This method cannot meet the requirement for the future terminals to collect information from the ubiquitous terminals that are around (since the packets are only transmitted from the ubiquitous terminals to the mobile terminal).

### SUMMARY OF THE INVENTION

A method and device for integrating a cellular network and a ubiquitous network is described. In one embodiment, the method for integrating a ubiquitous network and a cellular network, in which a communication between a mobile terminal and a base station is a duplex communication, the communication mode is time division multiplexing, and the mobile terminal in the cellular network communicates with the ubiquitous terminal by random accessing, polling or reservation, comprises the mobile terminal determining whether there are packets to be transmitted to the base station; if there are packets to be transmitted to the base station, the mobile terminal transmitting the reservation request signal to the base station, after receiving the reservation requests from all the mobile terminals, the base station generating uplink slot resource allocation information for the mobile terminal and the ubiquitous terminal and transmitting the information to the mobile terminals, and after receiving said information, mobile terminals that have packets to be transmitted transmitting the uplink packets; if there are no packets to be transmitted to the base station, the mobile terminal receiving the slot allocation result transmitted from the base station, the mobile terminals transmitting the notification of the start and end slots of the ubiquitous network resource to the around ubiquitous terminals when the ubiquitous network slot begins, after receiving the notification, the ubiquitous terminal starting the communication with the mobile terminal, the mobile terminal receiving the packets from the ubiquitous terminal, processing the received packets, and storing the packets to be transferred to the base station in a buffer, and the mobile terminal determining whether there are packets to be transmitted to the base station at the uplink slot of the next frame.

### BRIEF DESCRIPTION OF THE DRAWINGS

FIG. 1 shows the application scenario according to one embodiment of the present invention;

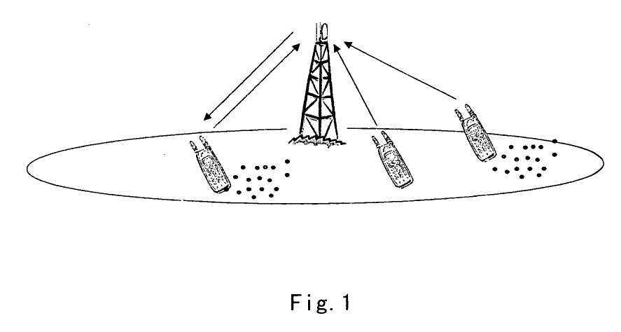

FIG. 2 is a schematic diagram showing the TDD/TD mode in the embodiments 1a and 1b according to one embodiment of the present invention;

FIG. 3 is the flow chart showing the processing flow in the embodiments 1a and 4a according to one embodiment of the present invention;

FIG. 4 is a diagram showing the architecture of the embodiments 1a and 1b according to one embodiment of the present invention;

FIG. 5 is a flow chart showing the processing flow in the embodiments 1b and 4b according to one embodiment of the present invention;

FIG. 6 is a schematic diagram showing the TDD/TD mode in the embodiments 2a and 2b according to one embodiment of the present invention;

FIG. 7 is a flow chart showing the processing flow in the embodiments 2a and 5a according to one embodiment of the present invention;

FIG. 8 is a diagram showing the architecture of the embodiments 2a and 2b according to one embodiment of the present invention;

FIG. 9 is a flow chart showing the processing flow in the embodiments 2b and 5b according to one embodiment of the present invention;

FIG. 10 is a schematic diagram showing the TDD/TD mode in the embodiment 3 according to one embodiment of the present invention;

FIG. 11 is a flow chart showing the processing flow in the embodiments 3 and 6 according to one embodiment of the present invention;

FIG. 12 is a diagram showing the architectures of the mobile terminal and the ubiquitous terminal in the embodiments 3 and 6 according to one embodiment of the present invention;

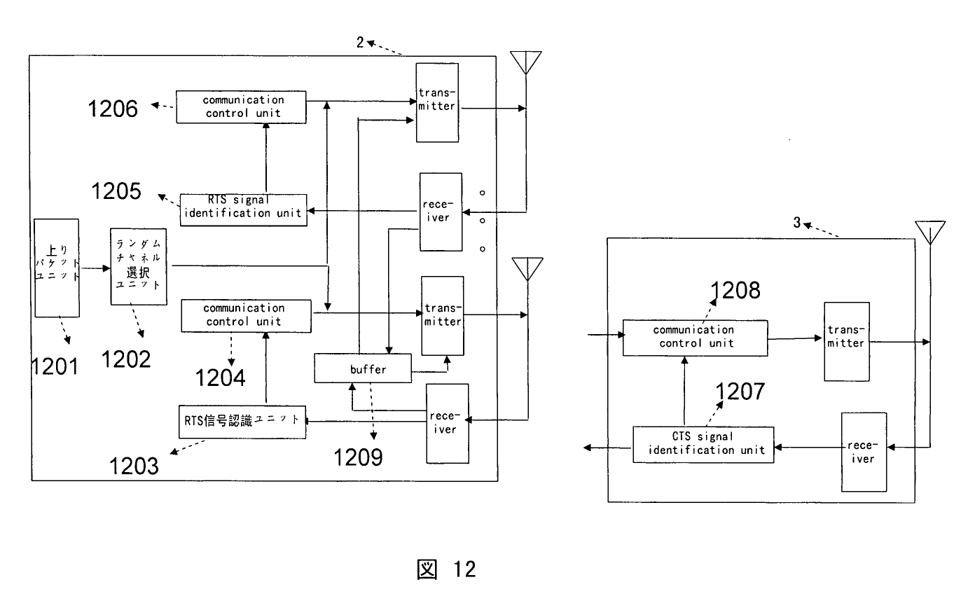

FIG. 13 is a schematic diagram showing the FDD/TD mode in the embodiments 4a and 4b according to one embodiment of the present invention;

FIG. 14 is a diagram showing the architectures of the base station, the mobile terminal and the ubiquitous terminal in the embodiments 4a and 4b according to one embodiment of the present invention;

FIG. 15 is a schematic diagram showing the FDD/FD mode in the embodiments 5a and 5b according to one embodiment of the present invention;

FIG. 16 is a diagram showing the architectures of the base station, the mobile terminal and the ubiquitous terminal in the embodiments 5a and 5b according to one embodiment of the present invention;

FIG. 17 is a schematic diagram showing the FDD/PD mode in the embodiment 6 according to one embodiment of the present invention;

FIGS. 18(a) and 18(b) show the traditional random access methods;

FIGS. 19(a) and 19(b) are schematic diagrams showing the traditional central control.

### DETAILED DESCRIPTION OF THE INVENTION

A method for integrating a ubiquitous network and a cellular network, wherein a communication between a mobile terminal and a base station is a duplex communication, the communication mode is time division multiplexing, and the mobile terminal in the cellular network communicates with the ubiquitous terminal by random accessing, polling or reservation is disclosed.

In one embodiment, the method includes the following steps: the mobile terminal determining whether there are packets to be transmitted to the base station; if there are packets to be transmitted to the base station, the mobile terminal transmitting the reservation request signal to the base station, after receiving the reservation requests from all the mobile terminals, the base station generating uplink slot resource allocation information for the mobile terminal and the ubiquitous terminal and transmitting the information to the mobile terminals, and after receiving the information, the mobile terminals that have packets to be transmitted transmitting the uplink packets; if there are no packets to be transmitted to the base station, the mobile terminal receiving the slot allocation result transmitted from the base station, the mobile terminals transmitting the notification of the start and end slots of the ubiquitous network resource to the around ubiquitous terminals when the ubiquitous network slot begins, after receiving the notification, the ubiquitous terminal starting the communication with the mobile terminal, the mobile terminal receiving the packets from the ubiquitous terminal, processing the received packets, and storing the packets to be transferred to the base station in a buffer, and the mobile terminal determining whether there are packets to be transmitted to the base station at the uplink slot of the next frame.

When the access modes of the mobile terminal and the ubiquitous terminal are the same, one embodiment of the method will be as the following: the mobile terminal determining whether there are packets to be transmitted to the base station; if there are packets to be transmitted to the base station, the mobile terminal transmitting a reservation request signal to the base station, after receiving the reservation requests from all the mobile terminals, the base station generating uplink slot resource allocation information for the mobile terminal and the ubiquitous terminal and transmitting the information through broadcast channels, and after receiving the information, the mobile terminal which have packets to be transmitted transmitting the uplink packets, and after receiving the information, the ubiquitous terminal starting the communication with the mobile terminal in available slots of the ubiquitous network; and if there are no packets to be transmitted to the base station, the mobile terminal receiving the slot allocation result transmitted from the base station, the mobile terminal starting the communication with the ubiquitous terminal during the ubiquitous network slots, processing the packets received from the ubiquitous terminal and storing the packets to be transferred to the base station in a buffer, and the mobile terminal determining whether there are packets to be transmitted to the base station at the uplink slot of the next frame.

When the communication mode is frequency division multiplexing, one embodiment of the method includes the following steps: the mobile terminal determining whether there are packets to be transmitted to the base station; if there are packets to be transmitted to the base station, the mobile terminal transmitting a reservation request to the base station, after receiving the reservation requests from all the mobile terminals, the base station generating uplink frequency band resource allocation information for the mobile terminal and the ubiquitous terminal and transmitting the information to the mobile terminals through the transmitter, and after receiving the information, the mobile terminals which have packets to be transmitted transmitting the uplink packets; and if there are no packets to be transmitted to the base station, the mobile terminal receiving the frequency band allocation result transmitted from the base station, the mobile terminals transmitting ubiquitous network resource allocation information to the around ubiquitous terminals at the ubiquitous network frequency band and starting the communication with the ubiquitous network, after receiving the information, the ubiquitous terminal starting the communication with the mobile terminal, and the mobile terminal processing the packets received from the ubiquitous terminals and storing the packets to be transferred to the base station in a buffer, and the mobile terminal determining whether there are packets to be transmitted to the base station at the uplink frequency band of the next frame.

When the access modes of the mobile terminal and the ubiquitous terminals are the same, one embodiment of the method will be as the following: the mobile terminal determining whether there are packets to be transmitted to the base station; if there are packets to be transmitted to the base station, the mobile terminal transmitting a reservation request signal to the base station, after receiving the reservation requests from all the mobile terminals, the base station generating uplink frequency band resource allocation information for the mobile terminal and the ubiquitous terminal and broadcasting the information, and after receiving the information, the mobile terminals which have packets to be transmitted transmitting the uplink packets, and after receiving the information, the ubiquitous terminals starting the communication with the mobile terminals in the ubiquitous network frequency band; and if there are no packets to be transmitted to the base station, the mobile terminal receiving the frequency band allocation result transmitted from the base station, the mobile terminal starting communication with the ubiquitous terminal during the ubiquitous network frequency band, the mobile terminal processing the packets received from the ubiquitous terminals and storing the packets to be transferred to the base station in a buffer, and the mobile terminal determining whether there are packets to be transmitted to the base station at the uplink frequency band of the next frame.

When the communication mode between the base station and the mobile terminal is the packet multiplexing, and the ubiquitous terminals communicate with the mobile terminals by random accessing, polling or reservation, one embodiment of the method includes the following steps: the mobile terminal determining whether there are packets to be transmitted to the base station; if there are packets to be transmitted to the base station, the mobile terminal randomly selecting an access channel to directly transmit the uplink packets to the base station; and if there are no packets to be transmitted to the base station, the mobile terminals have no packets to be transmitted or have already transmitted the uplink packets monitoring the multiple uplink channels simultaneously, the mobile terminal communicating with the neighboring ubiquitous terminal, and the mobile terminal processing the packets received from the ubiquitous terminal and storing the packets to be transferred to the base station in a buffer.

The mobile terminals and the ubiquitous terminals can randomly access the communication by sending RTS and CTS; it is not necessary for them to send RTS and CTS, since the terminal has packets to transmit will monitor the channel first. If the mobile terminal finds no terminal is transmitting data, it will wait DIFS and then transmits the packets, if it finds a terminal is transmitting the packets, it will wait until that terminal finishes transmitting and then waits DIFS and starts to transmit the packets after the backoff period. This method can be realized through the current random access device.

The communication between the mobile terminals and the ubiquitous terminals can be in the central control mode, such as polling and reservation.

The duplex mode can be the time division duplex or the frequency division duplex.

The mobile terminal stores the received packets which are transmitted from the base station to the ubiquitous terminal in the buffer, and when the mobile terminal communicates with the ubiquitous terminal, it transfers the packets to the ubiquitous terminal.

Embodiments of the present invention include a communication system, a base station, a mobile terminal and a ubiquitous terminal, in which the transmitter and the receiver in the mobile terminal and the base station perform time division duplex communication function in time division multiplexing mode, wherein, the mobile terminal also includes: an uplink signal reservation unit, a ubiquitous network resource notification unit, a downlink instruction identifier and a buffer, in which the uplink signal reservation unit is connected with the transmitter and is used to generate a reservation request,

the ubiquitous network resource notification unit is connected with the transmitter and is used to transmit ubiquitous network resource notification information and a slot for communication between the transmitter/receiver and the ubiquitous terminal or only a slot for communication between the transmitter/receiver and the ubiquitous terminal at a ubiquitous network slot notified by the base station,

the downlink instruction identifier is connected with the receiver and is used to identify a downlink instruction from the base station and to transmit the resource allocation information about the ubiquitous terminal to the ubiquitous network resource notification unit, and

the buffer is connected with the transmitter and the receiver and is used to store the received packets which are transmitted from the ubiquitous network or which are transmitted from the base station to the ubiquitous terminal;

the ubiquitous terminal includes: a ubiquitous network resource notification instruction identifier and a communication control unit, in which the ubiquitous network resource notification instruction identifier is connected with the transmitter and the communication control unit and is used to identify an instruction of the ubiquitous network resource start and end slots, which are transmitted by the ubiquitous network resource notification unit of the mobile terminal to the around ubiquitous terminals at the beginning of the ubiquitous network slot, or an instruction of the ubiquitous network resource allocation information transmitted by the base station, and is used to transmit the instruction to the communication control unit, and

the communication control unit is used to control the ubiquitous terminal to communicate with the mobile terminal according to the notification instruction; and
the base station also includes: a reservation request identifier, a cellular ubiquitous resource allocator and a resource allocation signal generator, in which the reservation request identifier is connected with the transmitter and the cellular ubiquitous network resource allocator and is used to receive a uplink reservation packet signal and to transmit the information in the signal to the cellular ubiquitous resource allocator,

the cellular ubiquitous resource allocator is used to generate the slot resource allocation information for the mobile terminal and the ubiquitous terminal and is used to transmit the information to the resource allocation signal generator, and

the resource allocation signal generator is used to generate the resource allocation signal.

Embodiments of the present invention include a communication system, a base station, a mobile terminal and a ubiquitous terminal, in which the transmitter and the receiver in the mobile terminal and the base station perform frequency division duplex communication function in frequency division multiplexing mode, wherein,

the mobile terminal also includes: an uplink signal reservation unit, a ubiquitous network resource notification unit, a downlink instruction identifier and a buffer, in which the uplink signal reservation unit is connected with the cellular transmitter and is used to transmit the number of the uplink reservation packets and the packet data needed to be transmitted of the mobile terminal,

the ubiquitous network resource notification unit is connected with the ubiquitous transmitter and is used to transmit an ubiquitous network resource notification instruction and a frequency band for communication between the ubiquitous transmitter/receiver and the ubiquitous terminal, or only a frequency band for communication between the transmitter/receiver and the ubiquitous terminal at the ubiquitous network frequency band notified by the base station,

the downlink instruction identifier is connected with the receiver and is used to identify a downlink instruction from the base station and to transmit the resource allocation information about the ubiquitous terminal to the ubiquitous network resource notification unit, and

the buffer is connected with the cellular transmitter, the ubiquitous transmitter and the receiver and is used to store the packets which are transmitted from the ubiquitous terminal or are transmitted from the base station to the ubiquitous terminal;

the ubiquitous terminal includes: a ubiquitous network resource notification instruction identifier and a communication control unit, in which the ubiquitous network resource notification instruction identifier is connected with the transmitter and the communication control unit and is used to identify a ubiquitous network resource allocation information instruction from the ubiquitous network resource notification unit of the mobile terminal or from the base station, and is used to transmit the instruction to the communication control unit, and

the communication control unit is used to control the ubiquitous terminal to communicate with the mobile terminal according to the specified frequency band in the notification instruction; and
the base station also includes: a reservation request identifier and a cellular ubiquitous resource allocator, in which the reservation request identifier is connected with the transmitter and the cellular ubiquitous network resource allocator and is used to receive a uplink reservation signal and to transmit the information in the signal to the cellular ubiquitous resource allocator, and

the cellular ubiquitous resource allocator is used to generate frequency band resource allocation information for the mobile terminal and the ubiquitous terminal according to the uplink reservation packet signals from all the mobile terminals and the counted ubiquitous network available resource.

Embodiments of the present invention include a communication system, a base station, a mobile terminal and a ubiquitous terminal, in which the transmitter and the receiver in the mobile terminal and the base station perform time or frequency division duplex communication function in packet multiplexing mode, wherein,

the mobile terminal further comprises a buffer, which is connected with each transmitter and receiver and is used to store packets which are transmitted from the base station to the ubiquitous terminal or are transmitted from the ubiquitous terminal to the base station.

In the system, the mobile terminal further comprises two RTS signal identification units, two communication control units, and a random channel selecting unit, in which the RTS signal identification units are used to respectively identify the RTS signal from the ubiquitous terminal and from the base station and each RTS signal identification unit is connected with a communication control unit and a receiver,

each of the communication control units is connected with a transmitter and is used to control the communication between the mobile terminal and the ubiquitous terminal and that between the mobile terminal and the base station, and

the random channel selecting unit is connected with an uplink packet unit and every transmitter and is used to randomly select the channel to transmit the uplink packets; and

the ubiquitous terminal comprises a CTS signal identification unit and a communication control unit, in which the CTS signal identification unit is connected with the receiver and the communication control unit (1208) and is used to identify the CTS signal from the mobile terminal and to transmit the CTS signal to the communication control unit, and

the communication control unit is connected with the transmitter and is used to control the communication between the ubiquitous terminal and the mobile terminal.

In the above system, it is not necessary for the mobile terminal to include a RTS signal identification unit and also it is not necessary for the ubiquitous terminal to include the CTS signal identification unit but both of them include the unit for listening to the channel; the terminal has packets to transmit will monitor the channel first, if it finds no terminal is transmitting data, it will wait DIFS and then transmits the packets, if it finds a terminal is transmitting the packets, it will wait until that terminal finishes transmitting and then waits DIFS and starts to transmit the packets after the backoff period.

Embodiments of the present invention include a communication system, a base station, a mobile terminal and a ubiquitous terminal, in which the transmitter and the receiver in the mobile terminal and the base station perform frequency division duplex communication function in time division multiplexing mode, wherein,

the mobile terminal also includes: an uplink signal reservation unit, a ubiquitous network resource notification unit, a downlink instruction identifier and a buffer, in which the uplink signal reservation unit is connected with the transmitter and is used to transmit the number of the uplink reservation packets,

the ubiquitous network resource notification unit is connected with the transmitter and is used to transmit ubiquitous network resource notification information and a slot for communication between the transmitter/receiver and the ubiquitous terminal or only a slot for communication between the transmitter/receiver and the ubiquitous terminal at the ubiquitous network slot notified by the base station,

the downlink instruction identifier is connected with the cellular receiver and is used to identify a downlink instruction from the base station and to transmit the resource allocation information about the ubiquitous terminal to the ubiquitous network resource notification unit, and

the buffer is connected with the transmitter and the ubiquitous receiver and is used to store the packets which are transmitted from the ubiquitous network or are transmitted from the base station to the ubiquitous terminal;

the ubiquitous terminal includes: a ubiquitous network resource notification instruction identifier and a communication control unit, in which the ubiquitous network resource notification instruction identifier is connected with the transmitter and the communication control unit and is used to identify an instruction of the ubiquitous network resource start and end slots, which are transmitted from the ubiquitous network resource notification unit of the mobile terminal to the around ubiquitous terminals at the beginning of the ubiquitous network slot, or an instruction of the ubiquitous network resource allocation information transmitted by the base station, and is used to transmit the instruction to the communication control unit; and

the communication control unit is used to control the ubiquitous terminal to communicate with the mobile terminal according to the notification instruction; and

the base station also includes: a reservation request identifier and a cellular ubiquitous resource allocator, in which the reservation request identifier is connected with the transmitter and the cellular ubiquitous network resource allocator and is used to receive a uplink reservation packet signal and to transmit the information in the signal to the cellular ubiquitous resource allocator, and

the cellular ubiquitous resource allocator is used to generate slot resource allocation information for the mobile terminal and the ubiquitous terminal according to the uplink reservation packet signals from all the mobile terminals and the counted ubiquitous network available resource.

Embodiments of the present invention include a communication system, a base station, a mobile terminal and a ubiquitous terminal, in which the transmitter and the receiver in the mobile terminal and the base station perform a frequency division duplex communication function in frequency division multiplexing mode, wherein,

the mobile terminal also includes: an uplink signal reservation unit, a downlink instruction identifier, a ubiquitous network resource notification unit, a ubiquitous network receiver, a ubiquitous network transmitter and a buffer, in which the uplink signal reservation unit is connected with the cellular transmitter and is used to transmit the number of the uplink reservation packets,

the downlink instruction identifier is connected with the cellular receiver and is used to identify a downlink instruction from the base station and to transmit resource allocation information about the ubiquitous terminal to the ubiquitous network resource notification unit,

the ubiquitous network resource notification unit is connected with the ubiquitous network transmitter and is used to transmit ubiquitous network resource notification information and a slot for the communication between the ubiquitous network transmitter/receiver and the terminal or only a slot for the communication between the ubiquitous network transmitter/receiver and the terminal at the ubiquitous network frequency band notified by the base station,

the ubiquitous network receiver is used to receive the packets from the ubiquitous network and to store the packets in the buffer,

the ubiquitous network transmitter is used to transmit the information to the ubiquitous network, and

the buffer is connected with the cellular transmitter, the cellular receiver, the ubiquitous network receiver and the ubiquitous network transmitter and is used to store the packets which are transmitted from the ubiquitous terminal or are transmitted from the base station to the ubiquitous terminal;

the ubiquitous terminal includes: a ubiquitous network resource notification instruction identifier and a communication control unit, in which the ubiquitous network resource notification instruction identifier is connected with the transmitter and the communication control unit and is used to identify a ubiquitous network resource allocation information instruction from the ubiquitous network resource notification unit of the mobile terminal or from the base station, and is used to transmit the instruction to the communication control unit, and

the communication control unit is used to control the ubiquitous terminal to communicate with the mobile terminal according to the specified frequency band in the notification instruction; and

the base station also includes: a reservation request identifier and a cellular ubiquitous resource allocator, in which the reservation request identifier is connected with the transmitter and the cellular ubiquitous network resource allocator and is used to receive the uplink reservation signal and to transmit the information in the signal to the cellular ubiquitous resource allocator, and

the cellular ubiquitous resource allocator is used to generate frequency band resource allocation information for the mobile terminal and the ubiquitous terminal according to the uplink reservation packet signals from all the mobile terminals and the accounted ubiquitous network available resource.

The above technical solution of the present invention integrates the cellular network and the ubiquitous network effectively, which not only saves the energy sources but also improves the frequency usage ratio. In addition, the ubiquitous network resource can be adaptively adjusted according to the amount of the uplink packets in the cellular network so that the adaptive convergence can be realized.

The present invention will be further illustrated with reference to the drawings.

The downlink flow of the present invention is the same with the traditional one, in which the base station transmits the packets to the mobile terminal by the downlink. If there are packets to be transmitted from the base station to the ubiquitous terminal, when the mobile terminal and the ubiquitous terminal adopt the same mode, the base station will transmit the packets to the ubiquitous terminal directly; and when the mobile terminal and the ubiquitous terminal adopt different modes, the mobile terminal will transfer the packets to the ubiquitous terminal. Therefore, the following will not describe the downlink processing in detail, and since the corresponding traditional communication method is used in the downlink communication, the following will only describe for the uplink in detail.

### Embodiment 1a

[TDD/TD] the cellular network uses the time division duplex (TDD) mode. The ubiquitous network and the cellular network are combined in the time divided multiplex (TD) mode, and they adopt different access modes. The cellular network access mode can be WCDMA while the ubiquitous network access mode can be UWB or bluetooth. The differences between the ubiquitous terminal and the mobile terminal are embodied in the transmitter and the receiver. The transmitter and the receiver related in the present invention have all the functions of the base station and the terminal in the WCDMA system in the prior art, such as the function of transmitting data, receiving data, and processing data. For example, if the communication mode is WCDMA, the base station and the terminal according to one embodiment of the present invention will have all the functions of the base station and terminal in the WCDMA system, in which the functions of signal processing relative to transmission, modulation and transmission are all realized by the transmitter in the present invention; the functions of receiving signal, demodulation and relative signal processing are all realized by the receiver in the present invention.

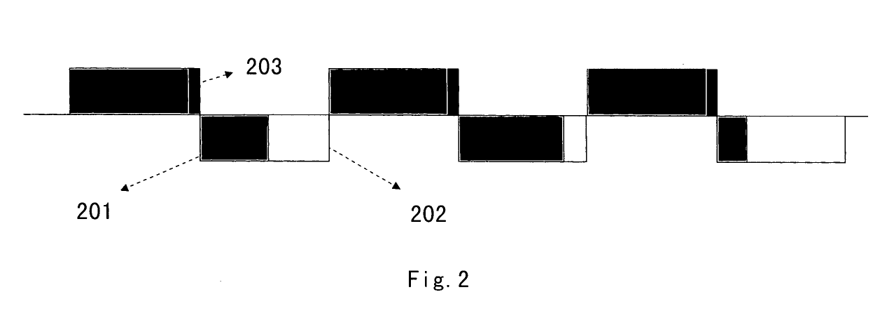

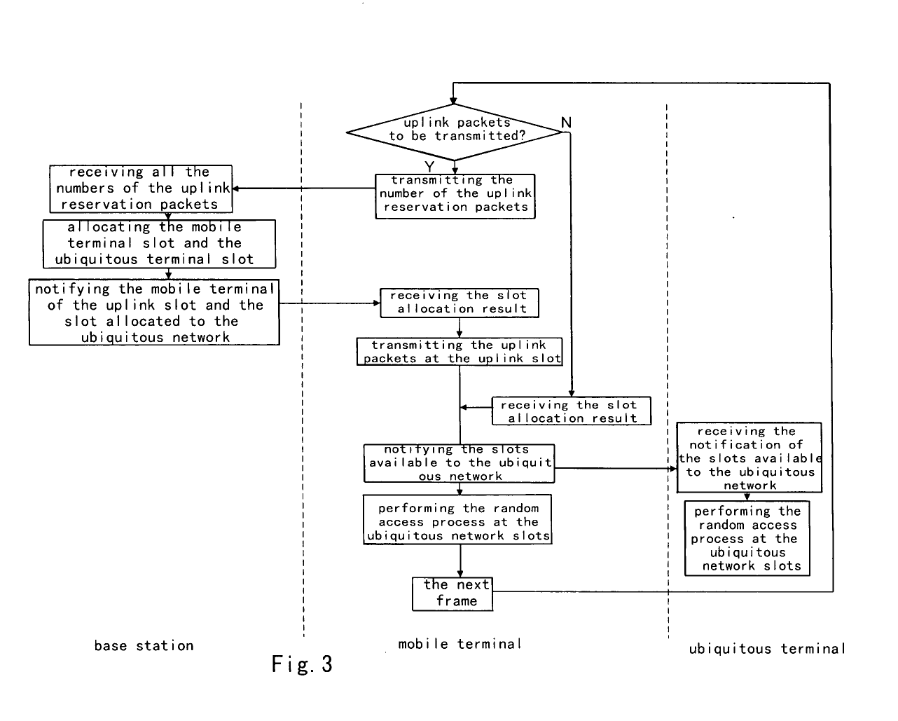

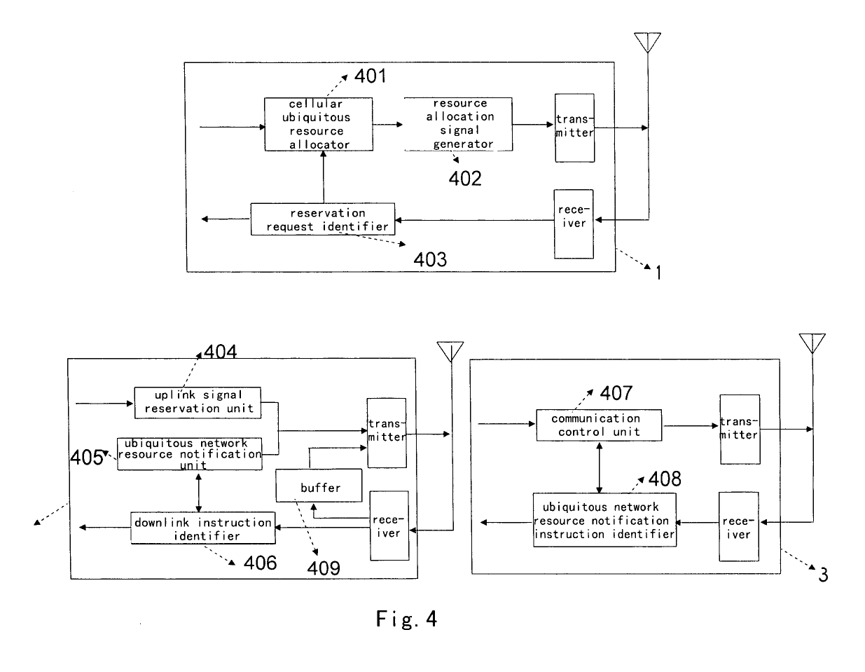

The basic concept diagram is shown in FIG. 2, wherein the uplink and downlink adopt the TDD mode and the base station and the terminal adopt the TDM mode. FIG. 3 shows the specific flow as follows (the architecture diagram for the base station, mobile terminal 2 and ubiquitous terminal 3 is shown in FIG. 4):

1) the mobile terminal determines whether there are packets to be transmitted.

2) if yes, the procedure proceeds to step 3); if no, the mobile terminal receives a slot allocation result transmitted from the base station and proceeds to step 7), wherein all the mobile terminals can receive the slot allocation result.

3) the uplink signal reservation unit 404 generates a reservation request and transmits the reservation request signal containing the number of the uplink reservation packets to the base station through the transmitter.

4) after receiving the reservation requests from all the mobile terminals, the reservation request identifier 403 of the base station transmits the request information to the cellular ubiquitous resource allocator 401.

5) the cellular ubiquitous network allocator 401 allocates the uplink slot resource for each mobile terminal, counts the slots available to the ubiquitous network, generates the uplink slot resource allocation information for the mobile terminal and the ubiquitous terminal (since the number of the uplink packets to be transmitted by each mobile terminal is different, the slots allocated to the ubiquitous network by the base station are also different), and transmits the resource allocation information to the resource allocation signal generator 402. The resource allocation signal generator 402 generates the resource allocation signal which is then transmitted by the transmitter in the downlink channel 203, and notifies each mobile terminal of the uplink slot 201 and the slot 202 available to the ubiquitous network (referring to FIG. 2).

6) after receiving the above-mentioned notification, the mobile terminal identifies the information in the notification through the downlink instruction identifier 406, and transmits the resource information allocated to the ubiquitous network to the ubiquitous network resource notification unit 405. Till then the mobile terminal which has packets to transmit can transmit the uplink packets.

7) through the transmitter, the ubiquitous network resource notification unit 405 transmits the notification of the start and end slots for the ubiquitous network resource to the around ubiquitous terminals when the ubiquitous network slot begins.

8) after identifying the notification, by the communication control unit 407 the ubiquitous resource notification instruction identifier 408 controls the ubiquitous terminal to perform the random access. During the random access process, the mobile terminal may transmit the received packets from the base station to the ubiquitous terminal, and may also receive the packets information transmitted from the ubiquitous terminal to itself or to the base station, store the packets which are transferred to the base station by itself in the buffer 409, and at the next uplink slot for the mobile terminal transfer the packets stored in the buffer 409 to the base station.

9) the procedure proceeds to step 1) at the uplink slot of the next frame.

Here the mode of the ubiquitous terminal is different from that of the mobile terminal, and the ubiquitous terminal cannot identify the signal transmitted from the base station. The mobile terminal receives the packets which are transmitted from the base station to the ubiquitous terminal, stores the packets in the buffer 409 and then transfers the packets to the ubiquitous terminal at the ubiquitous network communication slot. Similarly, the packets that are transmitted from the ubiquitous terminal to the base station are transferred through the mobile terminal and the mobile terminal doesn't communicate with the base station during the communication between the mobile terminal and the ubiquitous terminal. The ubiquitous terminal may be a wireless LAN terminal, UWB terminal, bluetooth terminal or the similar low power wireless terminal, which can communicate with the mobile terminal.

The mobile terminal includes: an uplink signal reservation unit 404, which is connected with the transmitter and is used to generate a reservation request including the number of the uplink reservation packets and transmit the reservation request to the base station through the transmitter; a ubiquitous network resource notification unit 405, which is connected with the transmitter and is used to transmit the ubiquitous network resource notification information at the ubiquitous network slot notified by the base station and notify the slots for the communication between the transmitter/receiver and the ubiquitous terminal; a downlink instruction identifier 406, which is connected with the receiver and is used to identify the downlink instruction from the base station and to transmit the resource allocation information about the ubiquitous terminal to the ubiquitous network resource notification unit 405; a buffer 409, which is connected with the transmitter and the receiver and is used to store the packets which are received from the ubiquitous network by the receiver and which are to be transmitted to the base station in the uplink slot through the transmitter and also is used to store the packets which are transmitted from the base station to the ubiquitous terminal and received by the receiver and which are to be transmitted to the ubiquitous terminal in the ubiquitous network slot through the transmitter.

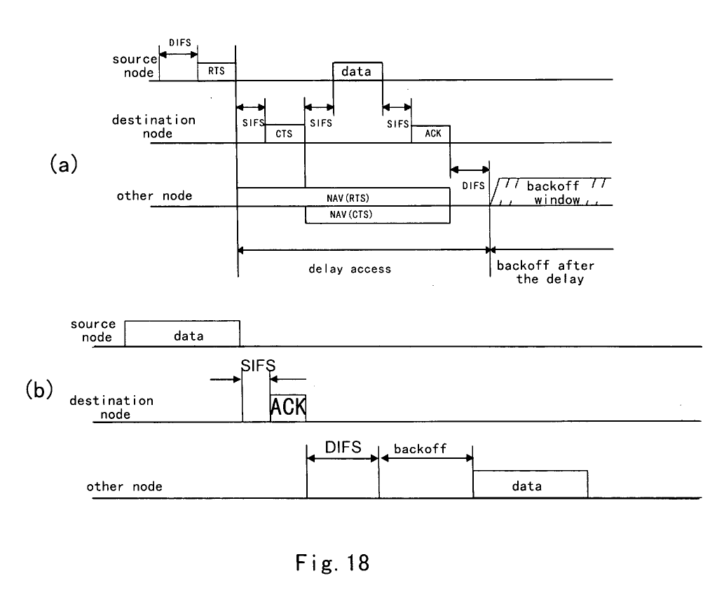

The ubiquitous terminal includes: a ubiquitous network resource notification instruction identifier 408, which is connected with the transmitter and the communication control unit 407 and is used to identify the instruction of the ubiquitous network resource start and end slots in which the instruction is transmitted by the ubiquitous network resource notification unit 405 of the mobile terminal to the ubiquitous terminals that are around at the beginning of the ubiquitous network slot, and to transmit the instruction to the communication control unit 407; a communication control unit 407, which is used to control the ubiquitous terminal to communicate with the mobile terminal according to the notification instruction, such as the transmitting and receiving of the random access shown in FIG. 18.

The base station also includes: a reservation request identifier 403, which is connected with the transmitter and the cellular ubiquitous network resource allocator 401 and is used to receive the uplink reservation packet signal and to transmit the information in the signal to the cellular ubiquitous resource allocator 401; a cellular ubiquitous resource allocator 401 which is used to generate the slot resource allocation information for the mobile terminal and the ubiquitous terminal according to the uplink reservation packet signals from all the mobile terminals, to count the resource available to the ubiquitous network and to transmit the information to the resource allocation signal generator 402; and a resource allocation signal generator 402 which is used to generate the resource allocation signal which is then transmitted to the mobile terminal by the transmitter.

The random access protocol includes the Carrier Sense Multiple Access with Collision Avoidance (CSMA/CA) protocol, in which each node decides independently when accessing the channel and if the access fails, the node re-accesses the channel after a backoff period. The distributed coordination function (DCF) in the wireless LAN also adopts the CSMA/CA protocol and it defines the handshake process based on RTS/CTS/DATA/ACK. Specifically, as FIG. 18(a) shows when there are packets to be transmitted to a node, the node will monitor the channel, and if the channel is idle and the idle time is longer than or equal to the DCF InterFrame Space (DIFS), the node will immediately send a short RTS(Request to Send); otherwise, if the channel is busy or the idle period is shorter than the DIFS, the node will perform the backoff when the channel is idle and the idle period is equal to the DIFS, and then the node will send a RTS after the backoff process. The backoff process is realized by the backoff window, which represents the backoff time. After correctly receiving the RTS and waiting for a short SIFS, the receive node returns a short CTS (Clear to send), which includes the receive node address RA copied from the transmit node address TA in the RTS and the duration for the transmission of the later packets. The duration here is equal to the duration in the received RTS from which the time for sending CTS packet and one SIFS are subtracted. After receiving the CTS packet, the transmit node will wait a SIFS and then transmit data packets. After receiving the packets, the receive node will wait a SIFS and then send an ACK to confirm.

FIG. 18(b) shows another example of random access, i.e., it is not necessary to send RTS and CTS and the terminal that has packets to transmit will monitor the channel first; if it finds no terminal is transmitting data, it will wait a DIFS and then transmits the packets; if it finds other terminal is transmitting the packets, it will wait until the other terminal finishes transmission and then waits a DIFS and starts to transmit the packets after the backoff process.

In addition, if the communication between the mobile terminals and the ubiquitous terminals is in the central control mode, the mode can be a polling or reservation mode.

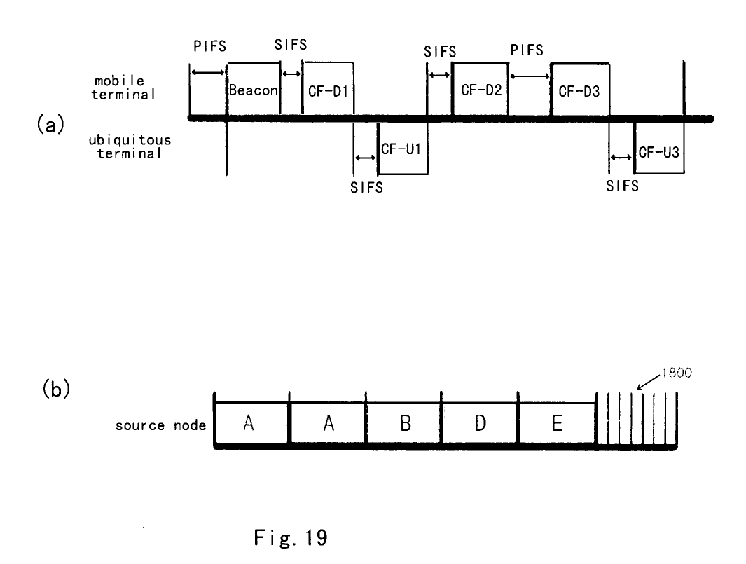

The polling mode is shown in FIG. 19(a), in which the mobile terminal sends a beacon frame after every super-frame length. Before sending the beacon frame, the mobile terminal will first monitor the channel and wait a PIFS [PCF (Point Coordination Function) InterFrame Space] and then sends the beacon frame. The mobile terminal polls the ubiquitous terminals in the polling list and the polling process is shown in FIG. 18 (c). DF-Di is the poll frame sent from the mobile terminal which carries the downlink data frame transmitted to the ubiquitous terminal i and CF-Ui is the uplink data frame from the polled ubiquitous terminal i. After polling, there will be two results: (1) the terminals in the polling list are all polled; (2) there is no enough time for the next terminal to be polled to transmit a minimum protocol unit.

The reservation mode is shown in FIG. 19(b). Every node has to book before transmitting data. The slots before every multiframe are used to transmit data and the last slot is divided into subslots 1800 that are specifically for reservation. The reservation request is performed in the slot ALOHA mode.

### Embodiment 1b

[TDD/TD] the cellular network uses the time division duplex (TDD) mode. The ubiquitous network and the cellular network are combined in the time divided multiplex (TD) mode, and they adopt different access modes, such as the TDM mode.

The basic concept diagram is shown in FIG. 2, wherein the uplink and downlink adopt the TDD mode and the base station and the terminal adopt the TDM mode.

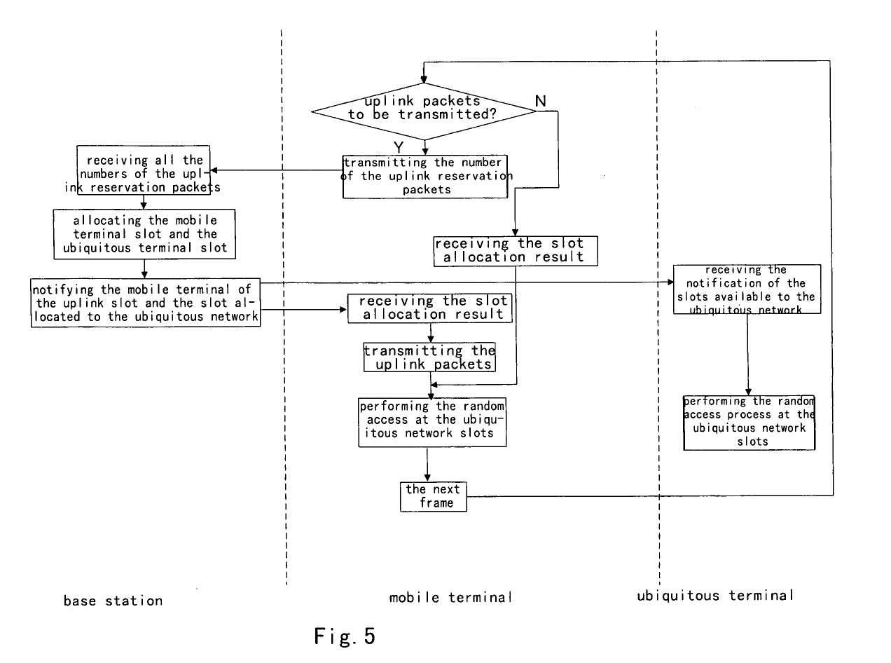

The flow is shown in FIG. 5 and the specific flow is as follows (the architectures of the base station, the mobile terminal and the ubiquitous terminal are shown in FIG. 4):

1) the mobile terminal determines whether there are packets to be transmitted.

2) if yes, the procedure proceeds to step 3); if no, receives the slot allocation result transmitted from the base station and proceeds to step 7), wherein all the mobile terminal can receive the slot allocation result.

3) the uplink signal reservation unit 404 generates a reservation request and transmits the reservation request signal to the base station through the transmitter.

4) after receiving the reservation requests from all the mobile terminals, the reservation request identifier 403 of the base station transmits the request information to the cellular ubiquitous resource allocator 401.

5) the cellular ubiquitous network allocator 401 allocates the uplink slot resource for each mobile terminal, counts the slots available to the ubiquitous network, generates the uplink slot resource allocation information for the mobile terminal and the ubiquitous terminal (since the number of the uplink packets to be transmitted by each mobile terminal in each frame is different, the slots allocated to the ubiquitous network by the base station are different also), and transmits the resource allocation information to the resource allocation signal generator 402. The resource allocation signal generator 402 generates the resource allocation signal which is then transmitted by the transmitter in the downlink channel 3, and notifies each mobile terminal of the uplink slot 1 and the slot 2 available to the ubiquitous network (referring to FIG. 2);

6) after receiving the above notification, the mobile terminal identifies the information in the resource allocation signal through the downlink instruction identifier 406 and the mobile terminal which has packets to transmit can transmit the uplink packets. After the ubiquitous terminal and the mobile terminal receive the slot available to the ubiquitous terminal at the same time, the ubiquitous resource notification instruction identifier 408 will identify first and then the communication control unit 407 will control the ubiquitous terminal to communicate with the mobile terminal in the available slot for the ubiquitous network.

7) the mobile terminal communicates with the ubiquitous terminal in the ubiquitous network slot, in which the mobile terminal may transmit the received packets from the base station to the ubiquitous terminal, and may also receive the packets transmitted from the ubiquitous terminal to itself or to the base station. And the mobile terminal stores the packets to be transferred to the base station in the buffer 409 and at the next uplink slot for the mobile terminal transfers the stored packets to the base station.

8) the procedure proceeds to step 1) at the uplink slot of the next frame.

In this embodiment, the access mode of the ubiquitous network is different from that of the cellular network. The ubiquitous terminal can identify the signal from the base station and can directly receive the packets from the base station. However, the packets transmitted from the ubiquitous terminal to the base station have to be transferred by the mobile terminal, so during the communication between the mobile terminal and the ubiquitous terminal, the mobile terminal doesn't communicate with the base station. The ubiquitous terminal may be a wireless LAN terminal, or the similar low power wireless terminals, which can communicate with the mobile terminal.

The mobile terminal includes: an uplink signal reservation unit 404, which is connected with the transmitter and is used to generate a reservation request including the number of the uplink reservation packets and transmit the reservation request to the base station through the transmitter; a ubiquitous network resource notification unit 405, which is connected with the transmitter and is used to transmit the ubiquitous network resource notification information at the ubiquitous network slot notified by the base station and notify the slots for the communication between the transmitter/receiver and the ubiquitous terminal; a downlink instruction identifier 406, which is connected with the receiver and is used to identify the downlink instruction from the base station and to transmit the resource allocation information about the ubiquitous terminal to the ubiquitous network resource notification unit 405; a buffer 409, which is connected with the transmitter and the receiver and is used to store the packets that are received from the ubiquitous network by the receiver and that are to be transmitted to the base station in the uplink slot through the transmitter.

The ubiquitous terminal includes: a ubiquitous network resource notification instruction identifier 408, which is connected with the transmitter and is used to identify the ubiquitous network resource allocation information transmitted from the base station to the ubiquitous terminal; a communication control unit 407, which is connected with the ubiquitous network resource notification instruction identifier 408 and is used to control the ubiquitous terminal to communicate with the mobile terminal according to the notification instruction from the ubiquitous network resource notification instruction identifier 408. For example, the communication control unit 407 controls the transmitting and receiving of the random access as shown in FIG. 18.

The base station also includes: a reservation request identifier 403, which is used to receive the uplink reservation packet signal; a cellular ubiquitous resource allocator 401 which is connected with the reservation request identifier 403, and is used to count the resource available to the ubiquitous network, and to generate and transmit the slot resource allocation information for the mobile terminal and the ubiquitous terminal according to the uplink reservation packet signals from all the mobile terminals; and a resource allocation signal generator 402 that is used to generate the resource allocation signal that is then transmitted to the mobile terminal by the transmitter according to the slot resource allocation information for the mobile terminal from the cellular ubiquitous resource allocator 401.

### Embodiment 2a

[TDD/TD] the cellular network adopts the TDD mode. The ubiquitous network and the cellular network are combined in the FDM mode. The ubiquitous network and the cellular network use different access modes.

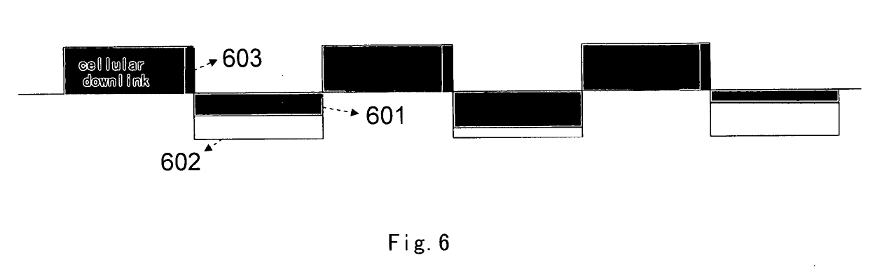

The basic concept is shown in FIG. 6, wherein both the uplink and the downlink use the TDD mode, and the base station communicates with the terminal in the FDM mode.

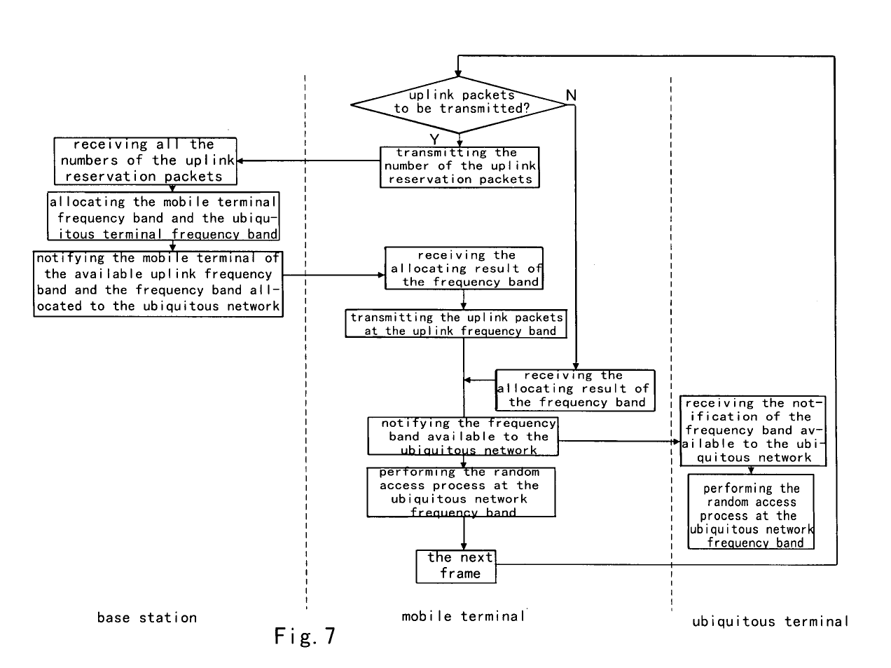

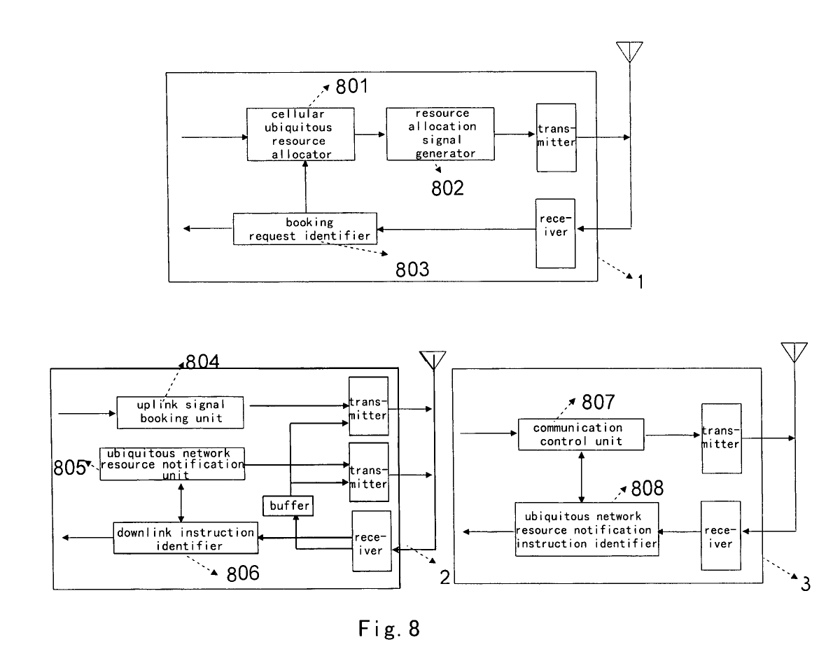

The flow is shown in FIG. 7 and the specific flow is as follows (the architectures of the base station, the mobile terminal and the ubiquitous terminal are shown in FIG. 8):

1) the mobile terminal determines whether there are packets to be transmitted.

2) if yes, the procedure proceeds to step 3); if no, receives the frequency band allocation result transmitted from the base station and proceeds to step 7), wherein all the mobile terminal can receive the frequency band allocation result.

3) the uplink signal reservation unit 804 generates a reservation request and transmits the reservation request signal to the base station through the transmitter.

4) after receiving the reservation requests from all the mobile terminals, the reservation request identifier 803 of the base station transmits the request information to the cellular ubiquitous resource allocator 801.

5) the cellular ubiquitous network allocator 801 allocates the uplink frequency band resource for each mobile terminal, counts the frequency bands available to the ubiquitous network, generates the uplink frequency band resource allocation information for the mobile terminal and the ubiquitous terminal (since the number of the uplink packets to be transmitted by each mobile terminal in each frame is different, the bandwidth allocated to the ubiquitous network by the base station is different also), and transmits the resource allocation information to the resource allocation signal generator 802. The resource allocation signal generator 802 generates the resource allocation signal that is transmitted by the transmitter in the downlink channel 603, and notifies each mobile terminal of the uplink frequency band 601 and the frequency band 602 available to the ubiquitous network (referring to FIG. 6).

6) after receiving the above notification, the mobile terminal identifies the information in the notification through the downlink instruction identifier 806 and transmits the resource information allocated to the ubiquitous network to the ubiquitous network resource notification unit 805. And then the mobile terminal that has packets to transmit can transmit the uplink packets.

7) through the transmitter, the ubiquitous network resource notification unit 805 transmits the ubiquitous network allocation information to the around ubiquitous terminals at the ubiquitous network frequency band and notifies them to communicate with the ubiquitous network.

8) after identifying the ubiquitous network resource allocation information, the ubiquitous resource notification instruction identifier 808 controls the ubiquitous terminal to communicate with the mobile terminal through the communication control unit 807. During the communication, the mobile terminal may buffer the packet information received by the base station, which is to be sent to the ubiquitous terminal, and then transmit the buffered packets to the ubiquitous terminal. And the mobile terminal may also receive the packets transmitted from the ubiquitous terminal to itself or to the base station, store the packets to be transferred to the base station in the buffer 409, and at the next uplink frequency band for the mobile terminal transfer the stored packets to the base station.

9) the procedure proceeds to step 1) at the uplink frequency band of the next frame.

Here the mode of the ubiquitous terminal is different from that of the mobile terminal and the ubiquitous terminal cannot identify the signal transmitted from the base station.

The mobile terminal includes: an uplink signal reservation unit 804, which is connected with the cellular transmitter and is used to transmit the number of the uplink reservation packets and the packet data needed to be transmitted; a ubiquitous network resource notification unit 805, which is connected with the ubiquitous transmitter and is used to transmit the ubiquitous network resource notification instruction at the ubiquitous network frequency band notified by the base station and to notify the frequency band for the communication between the ubiquitous transmitter/receiver and the ubiquitous terminal; a downlink instruction identifier 806, which is connected with the receiver and is used to identify the downlink instruction from the base station and to transmit the resource allocation information about the ubiquitous terminal to the ubiquitous network resource notification unit 805; a buffer 809, which is connected with the cellular transmitter, the ubiquitous transmitter and the receiver and is used to store the packets received by the receiver, which are sent from the ubiquitous terminal and then transmit the packets to the base station at the uplink frequency band of the mobile terminal through the first frequency band transmitter, or is used to store the packets that are transmitted from the base station to the ubiquitous terminal and then transmit the packets to the ubiquitous terminal at the ubiquitous network frequency band through the ubiquitous transmitter.

The ubiquitous terminal includes: a ubiquitous network resource notification instruction identifier 808, which is used to identify the ubiquitous network resource notification instruction from the ubiquitous network resource notification unit 805 of the mobile terminal; a communication control unit 807, which is connected with the ubiquitous network resource notification instruction identifier 808 and is used to control the ubiquitous terminal to communicate with the mobile terminal according to the specified frequency band in the notification instruction from the ubiquitous network resource notification instruction identifier 808.

The base station includes: a reservation request identifier 803, which is connected with the transmitter and is used to receive the uplink reservation signal; a cellular ubiquitous resource allocator 801, which is connected with the reservation request identifier 803, receives the information in the uplink reservation signal from the reservation request identifier 803, and is used to generate the frequency band resource allocation information for the mobile terminal and the ubiquitous terminal according to the uplink reservation packet signals from all the mobile terminals and count the ubiquitous network available resource and to transmit the information to the resource allocation signal generator 802; a resource allocation signal generator 802, which is used to generate the resource allocation signal and to transmit the signal to the mobile terminal through the transmitter.

### Embodiment 2b

[TDD/TD] the cellular network adopts the TDD mode. The ubiquitous network and the cellular network are combined in the FDM mode. The ubiquitous network and the cellular network use the same access mode.

The basic concept is shown in FIG. 6, wherein both the uplink and the downlink use the TDD mode, and the base station communicates with the terminal in the FDM mode.

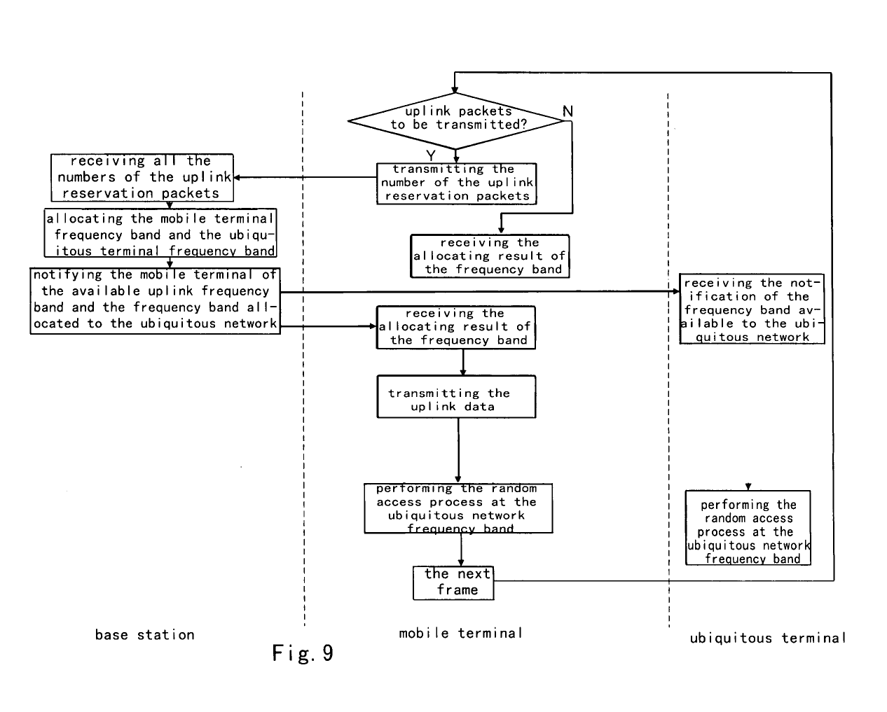

The flow is shown in FIG. 9 and the specific flow is as follows (the architectures of the base station, the mobile terminal and the ubiquitous terminal are shown in FIG. 8):

1) the mobile terminal determines whether there are packets to be transmitted.

2) if yes, the procedure proceeds to step 3); if no, receives the frequency band allocation result transmitted from the base station and proceeds to step 7), wherein all the mobile terminal can receive the frequency band allocation result.

3) the uplink signal reservation unit 804 generates a reservation request and transmits the reservation request signal to the base station through the transmitter.

4) after receiving the reservation requests from all the mobile terminals, the reservation request identifier 803 of the base station transmits the request information to the cellular ubiquitous resource allocator 801.

5) the cellular ubiquitous network allocator 801 allocates the uplink frequency band resource for each mobile terminal, counts the frequency bands available to the ubiquitous network, generates the uplink frequency band resource allocation information for the mobile terminal and the ubiquitous terminal (since the number of the uplink packets to be transmitted by each mobile terminal in each frame is different, the bandwidth allocated to the ubiquitous network by the base station is different also), and then transmits the resource allocation information to the resource allocation signal generator 802; the resource allocation signal generator 802 generates the resource allocation signal which is then broadcasted in the downlink channel 603, and notifies each mobile terminal of the uplink frequency band 601 and the frequency band 602 available to the ubiquitous network (referring to FIG. 6).

6) after receiving the above notification, the mobile terminal identifies the information in notification through the downlink instruction identifier 806 and the mobile terminal that has packets to transmit can transmit the uplink packets. After the ubiquitous terminal receives the notification of the frequency band available to the ubiquitous network, the ubiquitous resource notification instruction identifier will identify first, and if there are packets to be transmitted the communication control unit 807 will control the ubiquitous terminal to communicate with the mobile terminal at the available frequency band.

7) the mobile terminal communicates with the ubiquitous terminal at the ubiquitous network sub-carrier frequency band. During the communication, the mobile terminal may store the packets transmitted from the base station to the ubiquitous terminal in the buffer 809 and then transmit the buffered packets to the ubiquitous terminal at the ubiquitous network frequency band, and may also receive the packets from the ubiquitous terminal. If there are packets to be transferred to the base station, the mobile terminal will store the packets in the buffer 809 and at the next uplink frequency band for the mobile terminal transfer the stored packets to the base station.

8) the procedure proceeds to step 1) at the uplink frequency band of the next frame.

Here the mode of the ubiquitous terminal is the same with that of the mobile terminal and can receive the resource allocation information from the base station.

The mobile terminal includes: an uplink signal reservation unit 804, which is connected with the cellular transmitter and is used to transmit the number of the uplink reservation packets and the packet data needed to be transmitted; a ubiquitous network resource notification unit 805, which is connected with the ubiquitous transmitter and is used to notify the frequency band for the communication between the ubiquitous transmitter/receiver and the ubiquitous terminal; a downlink instruction identifier 806, which is connected with the receiver and is used to identify the downlink instruction from the base station and to transmit the resource allocation information about the ubiquitous terminal to the ubiquitous network resource notification unit 805; a buffer 809, which is connected with the cellular transmitter, the ubiquitous transmitter and the receiver and is used to store the packets received by the receiver, which are sent from the ubiquitous terminal, and then transmit the packets to the base station at the uplink frequency band of the mobile terminal through the cellular transmitter, or is used to store the packets which are transmitted from the base station to the ubiquitous terminal and then transmit the packets to the ubiquitous terminal at the ubiquitous network frequency band through the ubiquitous transmitter.

The ubiquitous terminal includes: a ubiquitous network resource notification instruction identifier 808, which is used to identify the ubiquitous network resource allocation notification instruction from the base station; a communication control unit 807, which is connected with ubiquitous network resource notification instruction identifier 808 and is used to control the ubiquitous terminal to communicate with the mobile terminal according to the specified frequency band in the notification instruction.

The base station includes: a reservation request identifier 803, which is connected with the transmitter and the cellular ubiquitous network resource allocator 801 and is used to receive the uplink reservation signal and to transmit the to the cellular ubiquitous resource allocator 801; a cellular ubiquitous resource allocator 801, which receives the information in the signal from the reservation request identifier 803 and is used to count the ubiquitous network available resource, and to generate and transmit the frequency band resource allocation information for the mobile terminal and the ubiquitous terminal according to the uplink reservation packet signals from all the mobile terminals; a resource allocation signal generator 802, which is used to generate the resource allocation signal and to transmit the signal to the mobile terminal through the transmitter.

### Embodiment 3

[TDD/TD] the cellular network adopts the TDD mode. The ubiquitous network and the cellular network are combined in the PDM (Packet Divided Multiplex) mode. During the uplink share period of the ubiquitous network and the cellular network, the mobile terminal can communicate with the base station (uplink) and can also communicate with the ubiquitous terminal. In the downlink channel, if the mobile terminal receives the packets transmitted from the base station to the ubiquitous terminal, it will store the packets in the buffer 1209 and after it communicates with the ubiquitous terminal, the mobile terminal will transmit the packets to the ubiquitous terminal.

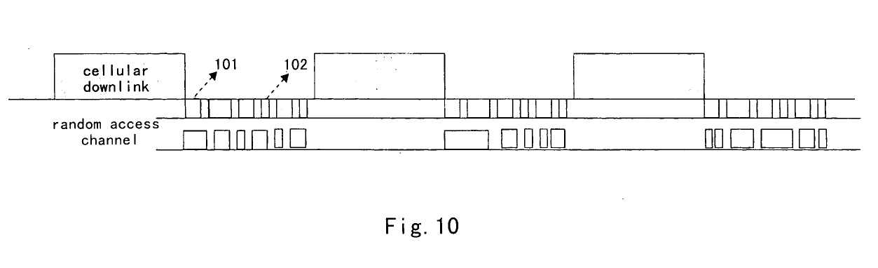

The basic concept is shown in FIG. 10, wherein reference sign 101 represents the cellular uplink channel and reference sign 102 represents the ubiquitous network random access channel. The cellular network uplink and the ubiquitous network share one or more random access channels.

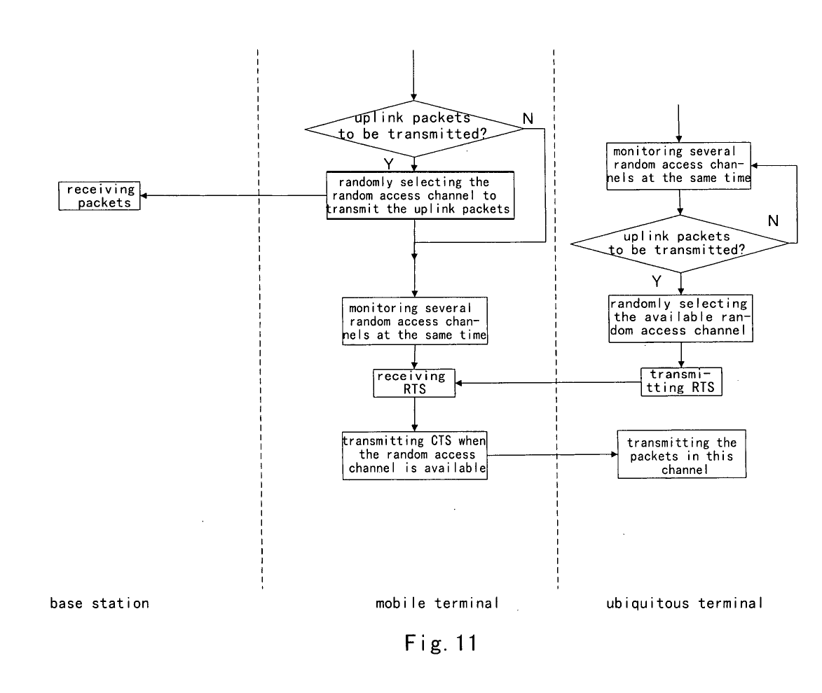

The flow is shown in FIG. 11.

1) the mobile terminal determines whether there are packets to be transmitted to the base station.

2) if yes, the procedure proceeds to step 3); if no, the procedure proceeds to step 4).

3) the mobile terminal randomly selects an access channel to directly transmit the uplink packets to the base station in the uplink period.

4) the mobile terminals that have no uplink packets or have already transmitted the uplink packets monitor the multiple random access channels at the same time.

5) the ubiquitous terminals monitor the multiple random access channels simultaneously.

6) the ubiquitous terminal determines whether there are packets to be transmitted;

7) if yes, the ubiquitous terminal selects an available access channel and sends a RTS signal to the mobile terminal and then proceeds to step 8); otherwise, the procedure returns to step 5).

8) after identifying the RTS from the ubiquitous terminal, the RTS signal identification unit of the mobile terminal determines whether the selected random access channel by the ubiquitous terminal is available.

9) if yes, the mobile terminal sends a CTS to the ubiquitous terminal (if this channel is used for other purpose simultaneously, such as the uplink packet transmission from the terminal, the transmission of the CTS can be delayed).

10) after identifying the CTS, the CTS signal identification unit 1207 of the ubiquitous terminal feeds back the information to the communication control unit 1208, and the communication control unit 1208 controls the ubiquitous terminal to transmit the packets to the mobile terminal.

During the communication between the mobile terminal and the ubiquitous terminal, the mobile terminal receives the packets transmitted from the ubiquitous terminal to itself or to the base station and stores the packets to be transferred to the base station in the buffer 1209. After the mobile terminal randomly accessed the base station, the packets stored in the buffer 1209 are transmitted to the base station. Similarly, the mobile terminal first receives the packets transmitted from the base station to the ubiquitous terminal, stores the packets in the buffer 1209 and after the mobile terminal communicates with the ubiquitous terminal, transmits the stored packets to the ubiquitous terminal.

The mobile terminal in the present embodiment includes: two RTS signal identification units 1203 and 1205, which are used to respectively identify the RTS signal from the ubiquitous terminal and from the base station and each of which is respectively connected with a receiver; a communication control unit 1204, which is connected with a transmitter and the two RTS signal identification units 1203 and 1205, and is used to control the communication between the mobile terminal and the ubiquitous terminal and between the mobile terminal and the base station; a random channel selecting unit 1202, which is connected with an uplink packet unit 1201 and every transmitter and is used to randomly select the channel to transmit the uplink packets; a buffer 1209, which is connected with each transmitter and receiver and is used to store the packets which are transmitted from the base station to the ubiquitous terminal or are transmitted from the ubiquitous terminal to the base station.

The ubiquitous terminal includes: a CTS signal identification unit 1207, which is connected with the receiver and is used to identify the CTS signal from the mobile terminal and then to transmit the CTS signal; a communication control unit 1208, which is connected with the transmitter and the CTS signal identification unit 1207 and is used to control the communication between the ubiquitous terminal and the mobile terminal. The base station here is a normal base station with the packet multiplexing function.

Similarly, the following access mode can be adopted:

1) the mobile terminal that has packets to be transmitted to the base station will monitor the channel first; if it finds there no terminal is transmitting data, it will wait a DIFS and then transmits the packets; if it finds a terminal is transmitting the packets, it will wait until that terminal finishes transmitting, then waits a DIFS and starts to transmit the packets after the backoff period;

2) the ubiquitous terminal that has packets to be transmitted to the base station will monitor the channel first; if it finds no terminal is transmitting data, it will wait a DIFS and then transmits the packets; if it finds a terminal is transmitting the packets, it will wait until that terminal finishes transmitting, then waits a DIFS and starts to transmit the packets after the backoff period;

3) the mobile terminal processes the packets from the ubiquitous terminal or from the base station and stores those packets to be transmitted to the base station or to the ubiquitous terminal in the buffer.

The mobile terminal here doesn't include a RTS signal identification unit and it is not necessary for the ubiquitous terminal to include a CTS signal identification unit but they both include a device to monitor the channel. The terminal which has packets to be transmitted will monitor the channel first, if it finds no terminal is transmitting data, it will wait a DIFS and then transmits the packets; if it finds a terminal is transmitting the packets, it will wait until that terminal finishes transmitting, then waits a DIFS and starts to transmit the packets after the backoff period.

### Embodiment 4a

[TDD/TD] the cellular network adopts the TDD mode. The ubiquitous network and the cellular network are combined in the FDM mode. The ubiquitous network and the cellular network use different access modes.

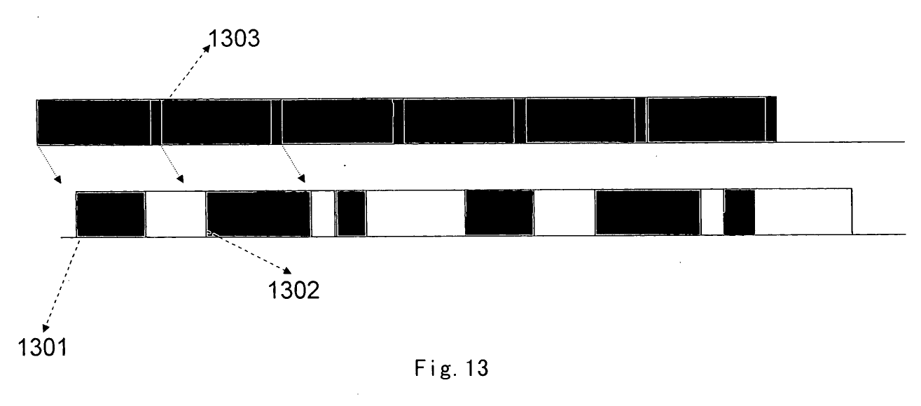

The basic concept is shown in FIG. 13.

The flow is shown in FIG. 3.

1) the mobile terminal determines whether there are packets to be transmitted.

2) if yes, the procedure proceeds to step 3); if no, the mobile terminal receives the slot allocation result transmitted from the base station and proceeds to step 7), wherein all the mobile terminal can receive the slot allocation result.

3) the uplink signal reservation unit 1404 generates a reservation request and transmits the reservation request signal to the base station through the transmitter, wherein the reservation request includes the number of the uplink reservation packets.

4) after receiving the reservation requests from all the mobile terminals, the reservation request identifier 1403 of the base station transmits the request information to the cellular ubiquitous resource allocator 1401.

5) the cellular ubiquitous network allocator 1401 allocates the uplink slot resource for each mobile terminal, counts the slots available to the ubiquitous network, generates the uplink slot resource allocation information for the mobile terminal and the ubiquitous terminal (since the number of the uplink packets to be transmitted by each mobile terminal in each frame is different, the slots allocated to the ubiquitous network by the base station are different also), and transmits the resource allocation information to the resource allocation signal generator 1402. The resource allocation signal generator 1402 generates the resource allocation signal, which is then transmitted by the transmitter in the downlink channel 1303, and notifies each mobile terminal of the uplink slot 1301 and the slot 1302 available to the ubiquitous network (referring to FIG. 13).

6) after receiving the above notification, the mobile terminal identifies the information in the notification through the downlink instruction identifier 1406 and transmits the resource information allocated to the ubiquitous network to the ubiquitous network resource notification unit 1405. And then the mobile terminal which has packets to transmit can transmit the uplink packets.

7) through the transmitter, the ubiquitous network resource notification unit 1405 transmits the start and end slot notification for the ubiquitous network resource to the ubiquitous terminals that are around when the ubiquitous network slot begins; then the mobile terminal performs the random access processing at the ubiquitous network slot.

8) after receiving the notification, by the communication control unit 407, the ubiquitous resource notification instruction identifier 1408 controls the ubiquitous terminal to perform the random access. During the communication, the mobile terminal may transmit the packets to the ubiquitous terminal, which are buffered in the buffer 1409 and received from the base station, and may also receive the packets transmitted from the ubiquitous terminal to itself or to the base station, store the packets to be transferred to the base station in the buffer 1409, and at the next uplink slot for the mobile terminal transfer the stored packets to the base station.

9) the procedure proceeds to step 1) at the uplink slot of the next frame.

Here the mode of the ubiquitous terminal is different from that of the mobile terminal and cannot identify the signal transmitted from the base station.

The mobile terminal includes: an uplink signal reservation unit 1404, which is connected with the transmitter and is used to transmit the number of the uplink reservation packets; a ubiquitous network resource notification unit 1405, which is connected with the transmitter and is used to transmit the ubiquitous network resource notification information and the slot for the communication between the transmitter/receiver and the ubiquitous terminal at the ubiquitous network slot notified by the base station; a downlink instruction identifier 1406, which is connected with the cellular receiver and is used to identify the downlink instruction from the base station and to transmit the resource allocation information about the ubiquitous terminal to the ubiquitous network resource notification unit 1405; a buffer 1409, which is connected with the transmitter and the ubiquitous receiver and is used to store the packets which are received from the ubiquitous network by the ubiquitous receiver and which are to be transmitted to the base station in the uplink slot through the transmitter, and also is used to store the packets that are transmitted from the base station to the ubiquitous terminal and received by the cellular receiver and that are to be transmitted to the ubiquitous terminal in the ubiquitous network slot through the transmitter.

The ubiquitous terminal includes: a ubiquitous network resource notification instruction identifier 1408, which is connected with the transmitter and is used to identify and transmit the instruction of the ubiquitous network resource start and end slots, which is transmitted by the ubiquitous network resource notification unit 1405 of the mobile terminal to the around ubiquitous terminals at the beginning of the ubiquitous network slot; a communication control unit 1407, which is connected with the ubiquitous network resource notification instruction identifier 1408 and is used to control the ubiquitous terminal to communicate with the mobile terminal according to the notification instruction as shown in FIGS. 18 (a) and 18 (b) in which the communication control unit 1407 controls the transmitting and receiving of the communication.

The base station includes: a reservation request identifier 1403, which is connected with the transmitter and is used to receive the uplink reservation packet signal and to transmit the information in the signal to the cellular ubiquitous resource allocator 1401; a cellular ubiquitous resource allocator 1401 which is connected with the reservation request identifier 1403 and is used to count the ubiquitous network available resource, and to generate and transmit the slot resource allocation information for the mobile terminal and the ubiquitous terminal according to the uplink reservation packet signals from all the mobile terminals, and to; a resource allocation signal generator 1402, which is used to generate the resource allocation signal and to transmit the signal to the mobile terminal through the transmitter.

### Embodiment 4b

[FDD/TD] the cellular network adopts the FDD mode. The ubiquitous network and the cellular network are combined in the TD mode. The ubiquitous network and the cellular network use the same access mode.

The basic concept is shown in FIG. 13.

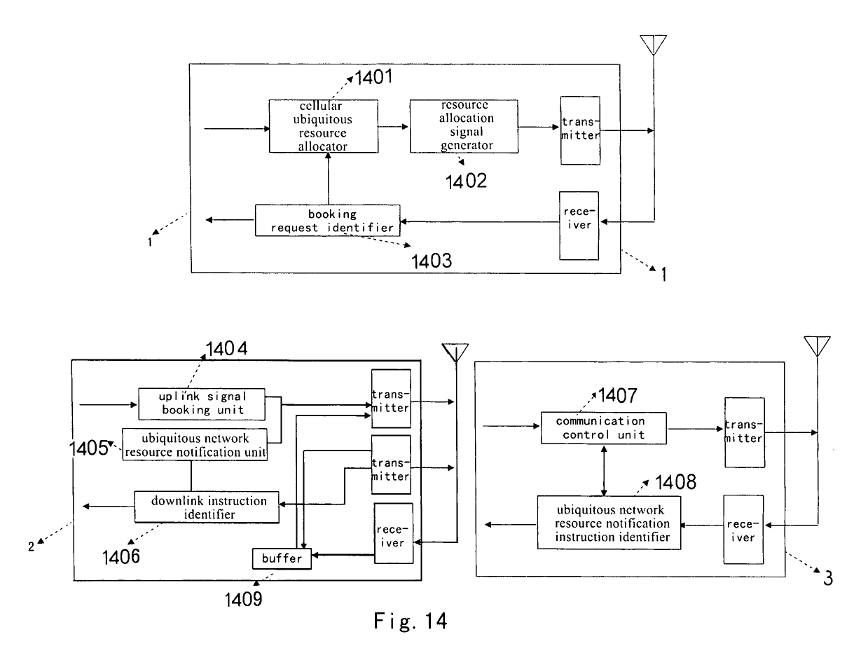

The flow is shown in FIG. 5 and the specific flow is as follows (the architectures of the base station, the mobile terminal and the ubiquitous terminal are shown in FIG. 14):

1) the mobile terminal determines whether there are packets to be transmitted.

2) if yes, the procedure proceeds to step 3); if no, the mobile terminal receives the slot allocation result transmitted from the base station and proceeds to step 7), wherein all the mobile terminal can receive the slot allocation result.

3) the uplink signal reservation unit 1404 generates a reservation request and transmits the reservation request signal to the base station through the transmitter.

4) after receiving the reservation requests from all the mobile terminals, the reservation request identifier 1403 of the base station transmits the request information to the cellular ubiquitous resource allocator 1401.

5) the cellular ubiquitous network allocator 1401 allocates the uplink slot resource for each mobile terminal, counts the slots available to the ubiquitous network, generates the uplink slot resource allocation information for the mobile terminal and the ubiquitous terminal (since the number of the uplink packets to be transmitted by each mobile terminal in each frame is different, the slots allocated to the ubiquitous network by the base station are different also), and transmits the resource allocation information to the resource allocation signal generator 1402. The resource allocation signal generator 1402 generates the resource allocation signal, which is then transmitted by the transmitter in the downlink channel 1303, and notifies each mobile terminal of the uplink slot 1301 and the slot 1302 available to the ubiquitous network (referring to FIG. 13).

6) after receiving the above notification, the mobile terminal identifies the information in the resource allocation signal through the downlink instruction identifier 1406. And the mobile terminal that has packets to be transmitted can transmit the uplink packets. After the ubiquitous terminal and the mobile terminal receive the slot available to the ubiquitous terminal simultaneously, the ubiquitous resource notification instruction identifier 1408 will identify first and then the communication control unit 1407 will control the ubiquitous terminal to communicate with the mobile terminal in the ubiquitous network available slot.

7) the mobile terminal communicates with the ubiquitous terminal in the ubiquitous network available slot. During the communication, the mobile terminal may transmit the received packets from the base station to the ubiquitous terminal, and may also receive the packets transmitted from the ubiquitous terminal to itself or to the base station, store the packets to be transferred to the base station in the buffer 1409 and at the next uplink slot for the mobile terminal transfer the stored packets to the base station.

8) the procedure proceeds to step 1) at the uplink slot of the next frame.

The mode of the ubiquitous terminal is the same with that of the mobile terminal and the ubiquitous terminal can identify the signal from the base station.

The mobile terminal includes: an uplink signal reservation unit 1404, which is connected with the transmitter and is used to transmit the number of the uplink reservation packets; a ubiquitous network resource notification unit 1405, which is connected with the transmitter and is used to notify the transmitter, the receiver and the ubiquitous terminal of the slot for the communication; a downlink instruction identifier 1406, which is connected with the cellular receiver and is used to identify the downlink instruction from the base station and to transmit the resource allocation information about the ubiquitous terminal to the ubiquitous network resource notification unit 1405; a buffer 1409, which is connected with the transmitter and the ubiquitous receiver and is used to store the packets which are received from the ubiquitous network by the ubiquitous receiver and which are to be transmitted to the base station in the uplink slot through the transmitter, and also is used to store the packets which are transmitted from the base station to the ubiquitous terminal and received by the cellular receiver and which are to be transmitted to the ubiquitous terminal in the ubiquitous network slot through the transmitter.

The ubiquitous terminal includes: a ubiquitous network resource notification instruction identifier 1408, which is connected with the transmitter and is used to identify the instruction of the ubiquitous network resource allocation information from the base station, and to transmit the instruction to the communication control unit 1407; a communication control unit 1407, which is connected with the ubiquitous network resource notification instruction identifier 1408 and is used to control the ubiquitous terminal to communicate with the mobile terminal according to the notification instruction. FIGS. 18 (a) and 18 (b) shows that the communication control unit 1407 controls the transmitting and receiving of the communication.

The base station includes: a reservation request identifier 1403, which is connected with the transmitter and is used to receive and transmit the uplink reservation packet signal; a cellular ubiquitous resource allocator 1401 which is used to count the ubiquitous network available resource, and generate and transmit the slot resource allocation information for the mobile terminal and the ubiquitous terminal according to the uplink reservation packet signals from all the mobile terminals; a resource allocation signal generator 1402 which is used to generate the resource allocation signal and transmit the signal to the mobile terminal through the transmitter.

### Embodiment 5a

[TDD/TD] the cellular network adopts the FDD mode. The ubiquitous network and the cellular network are combined in the FD mode. The ubiquitous network and the cellular network use different access modes.

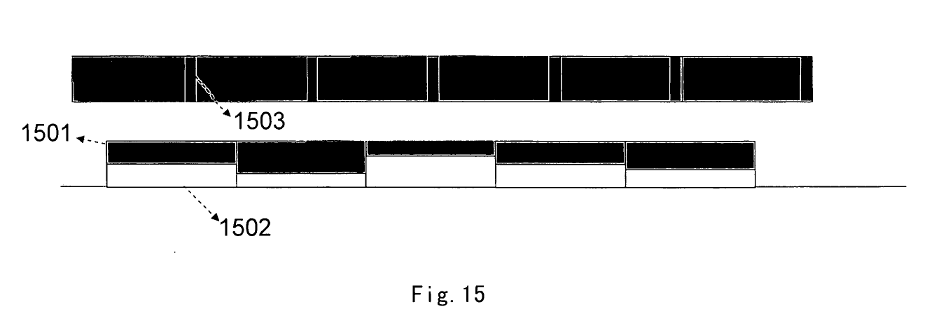

The basic concept is shown in FIG. 15.

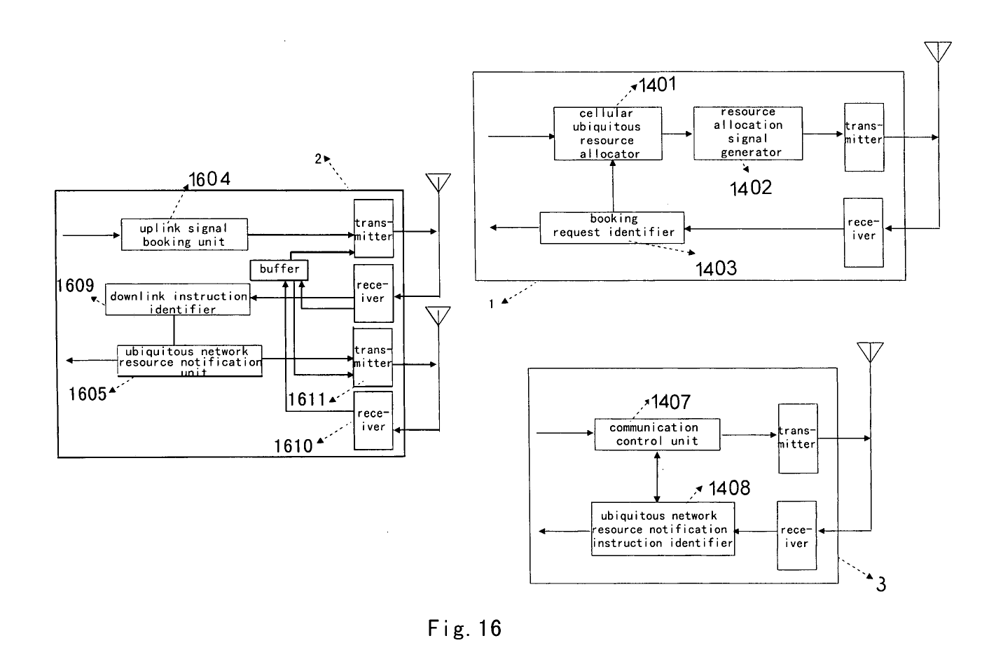

The flow is shown in FIG. 7 and the specific flow is as follows (the architectures of the base station, the mobile terminal and the ubiquitous terminal are shown in FIG. 16):

1) the mobile terminal determines whether there are packets to be transmitted.

2) if yes, the procedure proceeds to step 3); if no, the mobile terminal receives the slot allocation result transmitted from the base station and proceeds to step 7), wherein all the mobile terminal can receive the frequency band allocation result;

3) the uplink signal reservation unit 1604 generates a reservation request and transmits the reservation request signal to the base station through the transmitter.

4) after receiving the reservation requests from all the mobile terminals, the reservation request identifier 1603 of the base station transmits the request information to the cellular ubiquitous resource allocator 1601.

5) the cellular ubiquitous network allocator 1601 allocates the uplink frequency band resource for each mobile terminal, counts the frequency bands available to the ubiquitous network, generates the uplink frequency band resource allocation information for the mobile terminal and the ubiquitous terminal (since the number of the uplink packets to be transmitted by each mobile terminal in each frame is different, the bandwidth allocated to the ubiquitous network by the base station is different also), and transmits the resource allocation information to the resource allocation signal generator 1602. The resource allocation signal generator 1602 generates the resource allocation signal, which is transmitted by the transmitter in the downlink channel 1503, and notifies each mobile terminal of the uplink frequency band 1501 and the frequency band 1502 available to the ubiquitous network (refer to FIG. 15).

6) after receiving the above notification, the mobile terminal identifies the information in the notification through the downlink instruction identifier 1606 and transmits the resource information allocated to the ubiquitous network to the ubiquitous network resource notification unit 1605. And then the mobile terminal that has packets to be transmitted can transmit the uplink packets.

7) through the transmitter, the ubiquitous network resource notification unit 1605 transmits the range of the frequency band used by the ubiquitous network to the around ubiquitous terminals at the ubiquitous network frequency band and notifies them to communicate with the ubiquitous network.

8) after receiving the instruction of the range of the frequency band used by the ubiquitous network, the ubiquitous resource notification instruction identifier 1608 controls the ubiquitous terminal to communicate with the mobile terminal through the communication control unit 1607. During the communication, the mobile terminal may transmit the buffered packets received from the base station to the ubiquitous terminal, and may also receive the packets transmitted from the ubiquitous terminal to itself or to the base station, store the packets to be transferred to the base station in the buffer 1609, and at the next uplink frequency band for the mobile terminal transfer the stored packets to the base station.

9) the procedure proceeds to step 1) at the uplink frequency band of the next frame.

Here the mode of the ubiquitous terminal is different from that of the mobile terminal and the ubiquitous terminal cannot identify the signal transmitted from the base station.

The mobile terminal includes: an uplink signal reservation unit 1604, which is connected with the cellular transmitter and is used to transmit the number of the uplink reservation packets; a downlink instruction identifier 1606, which is connected with the cellular receiver and is used to identify the downlink instruction from the base station; a ubiquitous network resource notification unit 1605, which is connected with the ubiquitous network transmitter 1611 and is used to receive the resource allocation information about the ubiquitous terminal, to transmit the ubiquitous network resource notification instruction at the ubiquitous network frequency band notified by the base station and to notify the ubiquitous network transmitter, the ubiquitous network receiver and the ubiquitous terminal of the slot for the communication; a ubiquitous network receiver 1610, which is used to receive the packets from the ubiquitous network and to store the packets in the buffer 1609; a ubiquitous network transmitter 1611, which is used to transmit the information to the ubiquitous network; a buffer 1609, which is connected with the cellular transmitter, the cellular receiver, the ubiquitous network receiver and transmitter and is used to store the packets received by the ubiquitous network receiver, which are sent from the ubiquitous network, and then transmit the packets to the base station at the uplink slot of the mobile terminal by the first frequency band transmitter, or is used to store the packets received by the cellular receiver, which are transmitted from the base station to the ubiquitous terminal, and then transmit the packets to the ubiquitous terminal at the ubiquitous network slot by the ubiquitous network transmitter.

The ubiquitous terminal includes: a ubiquitous network resource notification instruction identifier 1608, which is connected with the transmitter and the communication control unit 1607 and is used to identify and transmit the instruction of the range of the frequency band from the ubiquitous network resource notification unit 1605 of the mobile terminal; a communication control unit 1607, which is used to control the ubiquitous terminal to communicate with the mobile terminal according to the specified frequency band in the notification instruction from the ubiquitous network resource notification instruction identifier 1608.

The base station includes: a reservation request identifier 1603, which is connected with the transmitter and the cellular ubiquitous network resource allocator 1601 and is used to receive the uplink reservation signal; a cellular ubiquitous resource allocator 1601, which is used to receive the information in the signal from the cellular ubiquitous network resource allocator 1601 and is used to count the ubiquitous network available resource, generate the frequency band resource allocation information for the mobile terminal and the ubiquitous terminal according to the uplink reservation packet signals from all the mobile terminals, and transmit the frequency band resource allocation information; a resource allocation signal generator 1602, which is used to generate the resource allocation signal and to transmit the signal to the mobile terminal through the transmitter.

### Embodiment 5b

[FDD/TD] the cellular network adopts the FDD mode. The ubiquitous network and the cellular network are combined in the FD mode. The ubiquitous network and the cellular network use the same access mode.

The basic concept is shown in FIG. 15.

The flow is shown in FIG. 9 and the specific flow is as follows (the architectures of the base station, the mobile terminal and the ubiquitous terminal are shown in FIG. 16):

1) the mobile terminal determines whether there are packets to be transmitted.

2) if yes, the procedure proceeds to step 3); if no, receives the slot allocation result transmitted from the base station and proceeds to step 7), wherein all the mobile terminal can receive the frequency band allocation result.

3) the uplink signal reservation unit 1604 generates a reservation request and transmits the reservation request signal to the base station through the transmitter.

4) after receiving the reservation requests from all the mobile terminals, the reservation request identifier 1603 of the base station transmits the request information to the cellular ubiquitous resource allocator 1601.

5) the cellular ubiquitous network allocator 1601 allocates the uplink frequency band resource for each mobile terminal, counts the frequency bands available to the ubiquitous network, generates the uplink frequency band resource allocation information for the mobile terminal and the ubiquitous terminal (since the number of the uplink packets to be transmitted by each mobile terminal in each frame is different, the bandwidth allocated to the ubiquitous network by the base station is different also), and then transmits the resource allocation information to the resource allocation signal generator 1602. The resource allocation signal generator 1602 generates the resource allocation signal, which is broadcasted in the downlink channel 1503, and notifies each mobile terminal of the uplink frequency band 1501 and the frequency band 1502 available to the ubiquitous network (referring to FIG. 15).

6) after receiving the above notification, the mobile terminal identifies the information in the notification through the downlink instruction identifier 1606 and transmits the resource information allocated to the ubiquitous network to the ubiquitous network resource notification unit 1605. And then the mobile terminal which has packets to be transmitted can transmit the uplink packets, and after the ubiquitous terminal receives the notification of the frequency band available to the ubiquitous network, the ubiquitous resource notification instruction identifier will identify first, and if there are packets to be transmitted the communication control unit 1607 will control the ubiquitous terminal to communicate the mobile terminal in the available frequency band.

7) the mobile terminal communicates with the ubiquitous terminal at the ubiquitous network subcarrier frequency band; during the communication, the mobile terminal may store the packets transmitted from the base station to the ubiquitous terminal in the buffer 1609 and then transmit the buffered packets to the ubiquitous terminal at the ubiquitous network frequency band, and may also receive the packets transmitted from the ubiquitous terminal to itself or to the base station and then store the packets to the base station in the buffer 1609 and at the next uplink frequency band belonging to the mobile terminal transfers the stored packets to the base station;

8) the procedure proceeds to step 1) at the uplink frequency band of the next frame.

Here the mode of the ubiquitous terminal is the same with that of the mobile terminal and the ubiquitous terminal can receive the resource allocation information from the base station.

The mobile terminal includes: an uplink signal reservation unit 1604, which is connected with the cellular transmitter and is used to transmit the number of the uplink reservation packets; a downlink instruction identifier 1606, which is connected with the cellular receiver and is used to identify the downlink instruction from the base station; a ubiquitous network resource notification unit 1605, which is connected with the ubiquitous network transmitter 1611 and is used to receive the resource allocation information about the ubiquitous terminal, and to notify the ubiquitous network transmitter, the ubiquitous network receiver and the ubiquitous terminal of the slot for the communication; a ubiquitous network receiver 1610, which is used to receive the packets from the ubiquitous network and to store the packets; a ubiquitous network transmitter 1611, which is used to transmit the information to the ubiquitous network; a buffer 1609, which is connected with the cellular transmitter, the cellular receiver and the ubiquitous network receiver and transmitter and is used to store the packets received by the ubiquitous network receiver 1610, which are transmitted from the ubiquitous network and to transmit the packets to the base station at the uplink slot of the mobile terminal through the first frequency band transmitter, or is used to store the packets received by the cellular receiver, which are transmitted from the base station to the ubiquitous terminal, and to transmit the packets to the ubiquitous terminal at the ubiquitous network slot through the ubiquitous network transmitter.

The ubiquitous terminal includes: a ubiquitous network resource notification instruction identifier 1608, which is connected with the transmitter and is used to identify the ubiquitous network resource allocation instruction from the base station; a communication control unit 1607, which is connected with the ubiquitous network resource notification instruction identifier 1608, and is used to control the ubiquitous terminal to communicate with the mobile terminal according to the specified frequency band in the notification instruction from the ubiquitous network resource notification instruction identifier 1608.

The base station includes: a reservation request identifier 1603, which is connected with the transmitter and is used to receive the uplink reservation signal; a cellular ubiquitous resource allocator 1601, which is connected with the reservation request identifier 1603, and is used to count ubiquitous network available resource, and to generate and transmit the frequency band resource allocation information for the mobile terminal and the ubiquitous terminal according to the uplink reservation packet signals from all the mobile terminals; a resource allocation signal generator 1602, which is used to generate the resource allocation signal and to transmit the signal to the mobile terminal through the transmitter.

### Embodiment 6

[FDD/PD] the cellular network adopts the FDD mode. The ubiquitous network and the cellular network are combined in the PD mode. The ubiquitous network and the cellular network use the same access mode.

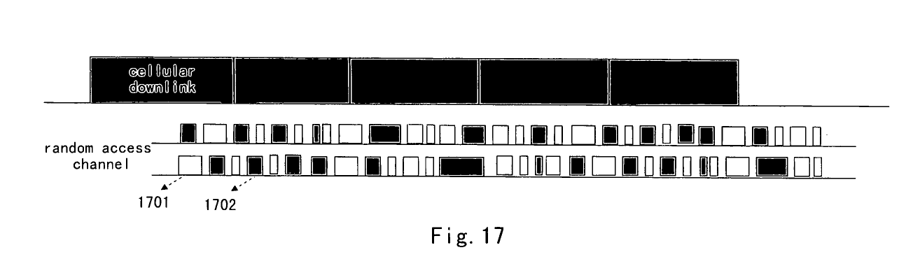

The basic concept is shown in FIG. 17, wherein reference sign 1701 represents the cellular uplink channel and reference sign 1702 represents the ubiquitous network random access channel. The cellular network uplink and the ubiquitous network share one or more random access channels.

The flow is shown in FIG. 11. The flow process of the present embodiment is the same with that of the embodiment 3. The differences are that in the present embodiment the cellular network adopts the FDD mode, the base station and the mobile terminal work in full duplex, and the access mode is packet multiplexing.

Though illustration and description of the present invention have been given with reference to preferred embodiments thereof, it should be appreciated by ordinary personnel skilled in the art that various changes in forms and details can be made without deviation from the spirit and scope of this invention as defined by the appended claims.

What is claimed is:

1. A method for integrating a ubiquitous network and a cellular network, in which a communication between a mobile terminal and a base station is a duplex communication, the communication mode is time division multiplexing, and the mobile terminal in the cellular network communicates with the ubiquitous terminal by random accessing, polling or reservation, the method comprising:
the mobile terminal determining whether there are packets to be transmitted to the base station;
if there are packets to be transmitted to the base station, the mobile terminal transmitting the reservation request signal to the base station,
after receiving the reservation requests from all the mobile terminals transmitting them, the base station generating uplink slot resource allocation information for the mobile terminal and the ubiquitous terminal and transmitting the information to the mobile terminals, and
after receiving the information, the mobile terminals that have packets to be transmitted transmitting the uplink packets;
if there are no packets to be transmitted to the base station, the mobile terminal receiving the slot allocation result transmitted from the base station,
the mobile terminals transmitting the notification of the start and end slots of the ubiquitous network resource to the around ubiquitous terminals when the ubiquitous network slot begins,
after receiving the notification, the ubiquitous terminal starting the communication with the mobile terminal, the mobile terminal receiving the packets from the ubiquitous terminal, processing the received packets, and storing the packets to be transferred to the base station in a buffer, and
the mobile terminal determining whether there are packets to be transmitted to the base station at the uplink slot of the next frame.

2. The method integrating a ubiquitous network and a cellular network according to claim 1, wherein,
the duplex mode is time division duplex or frequency division duplex.

3. A method for integrating a ubiquitous network and a cellular network, in which a communication between a mobile terminal and a base station is a duplex communication, the communication mode is time division multiplexing, and the mobile terminal in the cellular network communicates with the ubiquitous terminal by random accessing, polling or reservation, the method comprising:
the mobile terminal determining whether there are packets to be transmitted to the base station;
if there are packets to be transmitted to the base station, the mobile terminal transmitting a reservation request signal to the base station,
after receiving the reservation requests from all the mobile terminals transmitting them, the base station generating uplink slot resource allocation information for the mobile terminal and the ubiquitous terminal and transmitting the information through broadcast channels, and
after receiving the information, mobile terminals that have packets to be transmitted transmitting the uplink packets, and after receiving the information, the ubiquitous terminal starting the communication with the mobile terminal in available slots of the ubiquitous network; and
if there are no packets to be transmitted to the base station, the mobile terminal receiving the slot allocation result transmitted from the base station,
the mobile terminal starting the communication with the ubiquitous terminal during the ubiquitous network slots, processing the packets received from the ubiquitous terminal and storing the packets to be transferred to the base station in a buffer, and
the mobile terminal determining whether there are packets to be transmitted to the base station at the uplink slot of the next frame.

4. The method for integrating a ubiquitous network and a cellular network according to claim 3, wherein, the duplex mode is time division duplex or frequency division duplex.

5. A method for integrating a ubiquitous network and a cellular network, in which a communication between a mobile terminal and a base station is a duplex communication, the communication mode is frequency division multiplexing, and the mobile terminal in the cellular network communicates with the ubiquitous terminal by random accessing, polling or reservation, the method comprising:
the mobile terminal determining whether there are packets to be transmitted to the base station;
if there are packets to be transmitted to the base station, the mobile terminal transmitting a reservation request to the base station,
after receiving the reservation requests from all the mobile terminals transmitting them, the base station generating uplink frequency band resource allocation information for the mobile terminal and the ubiquitous terminal and transmitting the information to the mobile terminals through the transmitter, and
after receiving the information, mobile terminals that have packets to be transmitted transmitting the uplink packets; and
if there are no packets to be transmitted to the base station, the mobile terminal receiving the frequency band allocation result transmitted from the base station,
the mobile terminals transmitting ubiquitous network resource allocation information to the around ubiquitous terminals at the ubiquitous network frequency band and starting the communication with the ubiquitous network,
after receiving the information, the ubiquitous terminal starting the communication with the mobile terminal, and the mobile terminal processing the packets received from the ubiquitous terminals and storing the packets to be transferred to the base station in a buffer, and
the mobile terminal determining whether there are packets to be transmitted to the base station at the uplink frequency band of the next frame.

6. The method for integrating a ubiquitous network and a cellular network according to claim 5, wherein, the duplex mode is time division duplex or frequency division duplex.

7. A method for integrating a ubiquitous network and a cellular network, in which a communication between a mobile terminal and a base station is a duplex communication, the communication mode is frequency division multiplexing, and the mobile terminal in the cellular network communicates with the ubiquitous terminal by random accessing, polling or reservation, the method comprising:
the mobile terminal determining whether there are packets to be transmitted to the base station;
if there are packets to be transmitted to the base station, the mobile terminal transmitting a reservation request signal to the base station,
after receiving the reservation requests from all the mobile terminals transmitting them, the base station generating uplink frequency band resource allocation information for the mobile terminal and the ubiquitous terminal and broadcasting the information, and
after receiving the information, mobile terminals that have packets to be transmitted transmitting the uplink packets, and after receiving the information, the ubiquitous terminals starting the communication with the mobile terminals in the ubiquitous network frequency band; and
if there are no packets to be transmitted to the base station, the mobile terminal receiving the frequency band allocation result transmitted from the base station,
the mobile terminal starting communication with the ubiquitous terminal during the ubiquitous network frequency band, the mobile terminal processing the packets received from the ubiquitous terminals and storing the packets to be transferred to the base station in a buffer, and
the mobile terminal determining whether there are packets to be transmitted to the base station at the uplink frequency band of the next frame.

8. The method for integrating a ubiquitous network and a cellular network according to claim 7, wherein, the duplex mode is time division duplex or frequency division duplex.

9. A method for integrating a ubiquitous network and a cellular network, in which a communication between a mobile terminal and a base station is a duplex communication, the communication mode is packet multiplexing, and the mobile terminal in the cellular network communicates with the ubiquitous terminal by random accessing, polling or reservation, the method comprising:
the mobile terminal determining whether there are packets to be transmitted to the base station;
if there are packets to be transmitted to the base station, the mobile terminal randomly selecting an access channel to directly transmit the uplink packets to the base station; and
if there are no packets to be transmitted to the base station, mobile terminals that have no packets to be transmitted or that have already transmitted the uplink packets monitoring the multiple uplink channels simultaneously,
the mobile terminal communicating with the neighboring ubiquitous terminal, and
the mobile terminal processing the packets received from the ubiquitous terminal and storing the packets to be transferred to the base station in a buffer.

10. A method for integrating a ubiquitous network and a cellular network, in which a communication between a mobile terminal and a base station is a duplex communication, the communication mode is packet multiplexing, and the mobile terminal in the cellular network communicates with the ubiquitous terminal by random accessing, polling or reservation, the method comprising:
the mobile terminal that has packets to be transmitted to the base station monitoring the channel, and if it finds no terminal is transmitting data, the mobile terminal waiting a DIFS and transmitting the packets, and if it finds a terminal is transmitting the packets, the mobile terminal waiting until that terminal finishes transmitting, waiting a DIFS and then starting to transmit the packets after a backoff period;
the ubiquitous terminal which has packets to be transmitted to the base station monitoring the channel, if the ubiquitous terminal finds no terminal is transmitting data, it waiting a DIFS and transmits the packets, and if the ubiquitous terminal finds a terminal is transmitting the packets, the ubiquitous terminal waiting until that terminal finishes transmitting, waiting a DIFS and the starting to transmit the packets after a backoff period; and
the mobile terminal processing the packets from the ubiquitous terminal or from the base station and storing those packets to be transmitted to the base station or to the ubiquitous terminal in a buffer.

11. The method for integrating a ubiquitous network and a cellular network according to any one from claim 9 to claim 11, wherein, the duplex mode is time division duplex or frequency division duplex.

12. The method for integrating a ubiquitous network and a cellular network according to any one from claim 1 to claim 10, wherein,
the mobile terminal stores the received packets, which are transmitted from the base station to the ubiquitous terminal, in the buffer, and when the mobile terminal randomly accesses the ubiquitous terminal, the mobile terminal transfers the packets to the ubiquitous terminal.

13. A communication system, comprising a base station, a mobile terminal and a ubiquitous terminal, in which the transmitter and the receiver in the mobile terminal and the base station perform time division duplex communication function in time division multiplexing mode, wherein,
the mobile terminal further comprises an uplink signal reservation unit, a ubiquitous network resource notification unit, a downlink instruction identifier and a buffer, in which the uplink signal reservation unit is connected with the transmitter and is used to generate a reservation request,
the ubiquitous network resource notification unit is connected with the transmitter and is used to transmit ubiquitous network resource notification information and a slot for communication between the transmitter/receiver and the ubiquitous terminal or only a slot for communication between the transmitter/receiver and the ubiquitous terminal at a ubiquitous network slot notified by the base station,
the downlink instruction identifier is connected with the receiver and is used to identify a downlink instruction from the base station and to transmit the resource allocation information about the ubiquitous terminal to the ubiquitous network resource notification unit, and
the buffer is connected with the transmitter and the receiver and is used to store the received packets that are transmitted from the ubiquitous network or that are transmitted from the base station to the ubiquitous terminal;
the ubiquitous terminal comprises a ubiquitous network resource notification instruction identifier and a communication control unit, in which the ubiquitous network resource notification instruction identifier is connected with the transmitter and the communication control unit and is used to identify an instruction of the ubiquitous network resource start and end slots, which are transmitted by the ubiquitous network resource notification unit of the mobile terminal to the around ubiquitous terminals at the beginning of the ubiquitous network slot, or an instruction of the ubiquitous network resource allocation information transmitted by the base station, and is used to transmit the instruction to the communication control unit, and
the communication control unit is used to control the ubiquitous terminal to communicate with the mobile terminal according to the notification instruction; and
the base station further comprises a reservation request identifier, a cellular ubiquitous resource allocator and a resource allocation signal generator, in which the reservation request identifier is connected with the transmitter and the cellular ubiquitous network resource allocator and is used to receive a uplink reservation packet signal and to transmit the information in the signal to the cellular ubiquitous resource allocator,
the cellular ubiquitous resource allocator is used to generate the slot resource allocation information for the mobile terminal and the ubiquitous terminal and is used to transmit the information to the resource allocation signal generator, and
the resource allocation signal generator is used to generate the resource allocation signal.

14. A communication system, comprising a base station, a mobile terminal and a ubiquitous terminal, in which the transmitter and the receiver in the mobile terminal and the base station perform frequency division duplex communication function in frequency division multiplexing mode, wherein,
the mobile terminal further comprises an uplink signal reservation unit, a ubiquitous network resource notification unit, a downlink instruction identifier and a buffer, in which the uplink signal reservation unit is connected with the cellular transmitter and is used to transmit the number of the uplink reservation packets and the packet data needed to be transmitted of the mobile terminal,
the ubiquitous network resource notification unit is connected with the ubiquitous transmitter and is used to transmit an ubiquitous network resource notification instruction and a frequency band for communication between the ubiquitous transmitter/receiver and the ubiquitous terminal, or only a frequency band for communication between the transmitter/receiver and the ubiquitous terminal at the ubiquitous network frequency band notified by the base station,
the downlink instruction identifier is connected with the receiver and is used to identify a downlink instruction from the base station and to transmit the resource allocation information about the ubiquitous terminal to the ubiquitous network resource notification unit, and
the buffer is connected with the cellular transmitter, the ubiquitous transmitter and the receiver and is used to store the packets which are transmitted from the ubiquitous terminal or are transmitted from the base station to the ubiquitous terminal;
the ubiquitous terminal comprises a ubiquitous network resource notification instruction identifier and a communication control unit, in which the ubiquitous network resource notification instruction identifier is connected with the transmitter and the communication control unit and is used to identify a ubiquitous network resource allocation information instruction from the ubiquitous network resource notification unit of the mobile terminal or from the base station, and is used to transmit the instruction to the communication control unit, and
the communication control unit is used to control the ubiquitous terminal to communicate with the mobile terminal according to the specified frequency band in the notification instruction; and
the base station further comprises a reservation request identifier and a cellular ubiquitous resource allocator, in which the reservation request identifier is connected with the transmitter and the cellular ubiquitous network resource allocator and is used to receive a uplink reservation signal and to transmit the information in the signal to the cellular ubiquitous resource allocator, and
the cellular ubiquitous resource allocator is used to generate frequency band resource allocation information for the mobile terminal and the ubiquitous terminal according to the uplink reservation packet signals from all the mobile terminals and the counted ubiquitous network available resource.

15. A communication system, comprising a base station, a mobile terminal and a ubiquitous terminal, in which the transmitter and the receiver in the mobile terminal and the base station perform time or frequency division duplex communication function in packet multiplexing mode, wherein,
the mobile terminal further comprises a buffer, which is connected with each transmitter and receiver and is used to store packets which are transmitted from the base station to the ubiquitous terminal or are transmitted from the ubiquitous terminal to the base station.

16. The communication system according to claim 15, wherein,
the mobile terminal further comprises two RTS signal identification units, two communication control units, and a random channel selecting unit, in which the RTS signal identification units are used to respectively identify the RTS signal from the ubiquitous terminal and from the base station and each RTS signal identification unit is connected with a communication control unit and a receiver,
each of the communication control units is connected with a transmitter and is used to control the communication between the mobile terminal and the ubiquitous terminal and that between the mobile terminal and the base station, and
the random channel selecting unit is connected with an uplink packet unit and every transmitter and is used to randomly select the channel to transmit the uplink packets; and
the ubiquitous terminal comprises a CTS signal identification unit and a communication control unit, in which the CTS signal identification unit is connected with the receiver and the communication control unit and is used to identify the CTS signal from the mobile terminal and to transmit the CTS signal to the communication control unit, and
the communication control unit is connected with the transmitter and is used to control the communication between the ubiquitous terminal and the mobile terminal.

17. A communication system, comprising a base station, a mobile terminal and a ubiquitous terminal, in which the transmitter and the receiver in the mobile terminal and the base station perform frequency division duplex communication function in time division multiplexing mode, wherein,
the mobile terminal further comprises an uplink signal reservation unit, a ubiquitous network resource notification unit, a downlink instruction identifier and a buffer, in which the uplink signal reservation unit is connected with the transmitter and is used to transmit the number of the uplink reservation packets,
the ubiquitous network resource notification unit is connected with the transmitter and is used to transmit ubiquitous network resource notification information and a slot for communication between the transmitter/receiver and the ubiquitous terminal or only a slot for communication between the transmitter/receiver and the ubiquitous terminal at the ubiquitous network slot notified by the base station,
the downlink instruction identifier is connected with the cellular receiver and is used to identify a downlink instruction from the base station and to transmit the resource allocation information about the ubiquitous terminal to the ubiquitous network resource notification unit, and
the buffer is connected with the transmitter and the ubiquitous receiver and is used to store the packets which are transmitted from the ubiquitous network or are transmitted from the base station to the ubiquitous terminal;
the ubiquitous terminal comprises a ubiquitous network resource notification instruction identifier and a communication control unit, in which the ubiquitous network resource notification instruction identifier is connected with the transmitter and the communication control unit and is used to identify an instruction of the ubiquitous network resource start and end slots, which are transmitted from the ubiquitous network resource notification unit of the mobile terminal to the around ubiquitous terminals at the beginning of the ubiquitous network slot, or an instruction of the ubiquitous network resource allocation information transmitted by the base station, and is used to transmit the instruction to the communication control unit; and
the communication control unit is used to control the ubiquitous terminal to communicate with the mobile terminal according to the notification instruction; and
the base station further comprises a reservation request identifier and a cellular ubiquitous resource allocator, in which the reservation request identifier is connected with the transmitter and the cellular ubiquitous network resource allocator and is used to receive a uplink reservation packet signal and to transmit the information in the signal to the cellular ubiquitous resource allocator, and
the cellular ubiquitous resource allocator is used to generate slot resource allocation information for the mobile terminal and the ubiquitous terminal according to the uplink reservation packet signals from all the mobile terminals and the counted ubiquitous network available resource.

18. A communication system, comprising a base station, a mobile terminal and a ubiquitous terminal, in which the transmitter and the receiver in the mobile terminal and the base station perform a frequency division duplex communication function in frequency division multiplexing mode, wherein,
the mobile terminal further comprises an uplink signal reservation unit, a downlink instruction identifier, a ubiquitous network resource notification unit, a ubiquitous network receiver, a ubiquitous network transmitter and a buffer, in which the uplink signal reservation unit is connected with the cellular transmitter and is used to transmit the number of the uplink reservation packets,
the downlink instruction identifier is connected with the cellular receiver and is used to identify a downlink instruction from the base station and to transmit resource allocation information about the ubiquitous terminal to the ubiquitous network resource notification unit,
the ubiquitous network resource notification unit is connected with the ubiquitous network transmitter and is used to transmit ubiquitous network resource notification information and a slot for the communication between the ubiquitous network transmitter/receiver and the terminal or only a slot for the communication between the ubiquitous network transmitter/receiver and the terminal at the ubiquitous network frequency band notified by the base station,
the ubiquitous network receiver is used to receive the packets from the ubiquitous network and to store the packets in the buffer,
the ubiquitous network transmitter is used to transmit the information to the ubiquitous network, and
the buffer is connected with the cellular transmitter, the cellular receiver, the ubiquitous network receiver and the ubiquitous network transmitter and is used to store the packets which are transmitted from the ubiquitous terminal or are transmitted from the base station to the ubiquitous terminal;
the ubiquitous terminal comprises a ubiquitous network resource notification instruction identifier and a communication control unit, in which the ubiquitous network resource notification instruction identifier is connected with the transmitter and the communication control unit and is used to identify a ubiquitous network resource allocation information instruction from the ubiquitous network resource notification unit of the mobile terminal or from the base station, and is used to transmit the instruction to the communication control unit, and
the communication control unit is used to control the ubiquitous terminal to communicate with the mobile terminal according to the specified frequency band in the notification instruction; and
the base station further comprises a reservation request identifier and a cellular ubiquitous resource allocator, in which the reservation request identifier is connected with the transmitter and the cellular ubiquitous network resource allocator and is used to receive the uplink reservation signal and to transmit the information in the signal to the cellular ubiquitous resource allocator, and
the cellular ubiquitous resource allocator is used to generate frequency band resource allocation information for the mobile terminal and the ubiquitous terminal according to the uplink reservation packet signals from all the mobile terminals and the accounted ubiquitous network available resource.

19. A base station, comprising a transmitter and a receiver, in which the transmitter and the receiver perform duplex communication function in time or frequency division multiplexing modes, wherein, the base station further comprising:
a reservation request identifier connected with the transmitter and is used to receive the uplink reservation signal; and
a cellular ubiquitous resource allocator connected with the reservation request identifier and is used to generate frequency band resource allocation information for the mobile terminal and the ubiquitous terminal according to the uplink reservation packet signals from all the mobile terminals and the accounted ubiquitous network available resource.

20. A mobile terminal, comprising a transmitter and a receiver, in which the transmitter and the receiver perform a time division duplex communication function in time division multiplexing mode, further comprising:
an uplink signal reservation unit connected with the transmitter and is used to generate a reservation request;
a ubiquitous network resource notification unit connected with the transmitter and is used to transmit ubiquitous network resource notification information and a slot for communication between the transmitter/receiver and the ubiquitous terminal or only a slot for communication between the transmitter/receiver and the ubiquitous terminal at the ubiquitous network slot notified by the base station;
a downlink instruction identifier connected with the receiver and is used to identify a downlink instruction from the base station and to transmit the resource allocation information about the ubiquitous terminal to the ubiquitous network resource notification unit; and
a buffer connected with the transmitter and the receiver and is used to store the received packets that are transmitted from the ubiquitous network or that are transmitted from the base station to the ubiquitous terminal.

21. A mobile terminal, comprising a transmitter and a receiver, in which the transmitter and the receiver perform a frequency division duplex communication function in time division multiplexing mode, further comprising:
an uplink signal reservation unit connected with the cellular transmitter and is used to transmit the number of the uplink reservation packets and the packet data needed to be transmitted of the mobile terminal;
a ubiquitous network resource notification unit connected with the ubiquitous transmitter and is used to transmit a ubiquitous network resource notification instruction and a frequency band for communication between the ubiquitous transmitter/receiver and the ubiquitous terminal or only a frequency band for communication between the transmitter/receiver and the ubiquitous terminal at the ubiquitous network frequency band notified by the base station;
a downlink instruction identifier connected with the receiver and is used to identify the downlink instruction from the base station and to transmit the resource allocation information about the ubiquitous terminal to the ubiquitous network resource notification unit; and
a buffer connected with the cellular transmitter, the ubiquitous transmitter and the receiver and is used to store the packets that are transmitted from the ubiquitous terminal or are transmitted from the base station to the ubiquitous terminal.

22. A mobile terminal, comprising a transmitter and a receiver, in which the transmitter and the receiver perform a time or frequency division duplex communication function in packet multiplexing mode, further comprising:
a buffer is connected with each transmitter and receiver and is used to store packets that are transmitted from the base station to the ubiquitous terminal or are transmitted from the ubiquitous terminal to the base station.

23. The mobile terminal according to claim 22, further comprising:
two RTS signal identification units to respectively identify the RTS signal from the ubiquitous terminal and that from the base station and each of which is connected with a receiver;
two communication control units, each of which is connected with a transmitter and a RTS signal identification unit, and is used to control communication between the mobile terminal and the ubiquitous terminal and communication between the mobile terminal and the base station; and
a random channel selecting unit connected with an uplink packet unit and every transmitter and is used to randomly select a channel to transmit the uplink packets.

24. A mobile terminal, comprising a transmitter and a receiver, in which the transmitter and the receiver perform a frequency division duplex communication function in time division multiplexing mode, further comprising:
an uplink signal reservation unit connected with the transmitter and is used to transmit the number of the uplink reservation packets;
a ubiquitous network resource notification unit connected with the transmitter and is used to transmit ubiquitous network resource notification information and a slot for communication between the transmitter/receiver and the ubiquitous terminal or only a slot for communication between the transmitter/receiver and the ubiquitous terminal at the ubiquitous network slot notified by the base station;
a downlink instruction identifier connected with the cellular receiver and is used to identify a downlink instruction from the base station and to transmit the resource allocation information about the ubiquitous terminal to the ubiquitous network resource notification unit; and
a buffer connected with the transmitter and the ubiquitous receiver and is used to store the packets which are transmitted from the ubiquitous network or are transmitted from the base station to the ubiquitous terminal.

25. A mobile terminal, comprising a transmitter and a receiver, in which the transmitter and the receiver perform a frequency division duplex communication function in frequency division multiplexing mode, wherein,
the mobile terminal further comprises:
an uplink signal reservation unit connected with the cellular transmitter and is used to transmit the number of the uplink reservation packets;
a downlink instruction identifier connected with the cellular receiver and is used to identify a downlink instruction from the base station and to transmit the resource allocation information about the ubiquitous terminal;
a ubiquitous network resource notification unit connected with the ubiquitous network transmitter and is used to receive the resource allocation information about the ubiquitous terminal, and transmit ubiquitous network resource notification information and a slot for communication between the ubiquitous network transmitter/receiver and the terminal or only a slot for communication between the ubiquitous network transmitter/receiver and the terminal at the ubiquitous network frequency band notified by the base station;
a ubiquitous network receiver to receive the packets from the ubiquitous network and to store the packets;
a ubiquitous network transmitter to transmit the information to the ubiquitous network; and
a buffer connected with the cellular transmitter, the cellular receiver, the ubiquitous network receiver and the ubiquitous network transmitter and is used to store the packets which are transmitted from the ubiquitous terminal or are transmitted from the base station to the ubiquitous terminal.

26. A ubiquitous terminal, comprising a transmitter and a receiver, in which the transmitter and the receiver perform a communication function, further comprising:
a ubiquitous network resource notification instruction identifier\connected with the transmitter and is used to identify a ubiquitous network resource allocation information instruction from the mobile terminal or from the base station, and to transmit the instruction to the communication control unit; and
a communication control unit connected with the ubiquitous network resource notification instruction identifier, and is used to control the ubiquitous terminal to communicate with the mobile terminal according to the specified frequency band in the notification instruction from the ubiquitous network resource notification instruction identifier.
